(19) United States
(12) Patent Application Publication
(10) Pub. No.: US 2009/0213298 A1
(43) Pub. Date: Aug. 27, 2009

(54) OPTICAL MODULATING DISPALY DEVICE AND PRODUCTION METHOD THEREFOR AND DISPLAY APPARATUS MOUNTING THE OPTICAL MODULATING DISPLAY DEVICE THEREON

(75) Inventors: Koji Mimura, Tokyo (JP); Ken Sumiyoshi, Tokyo (JP); Goroh Saitoh, Tokyo (JP); Jin Matsusima, Tokyo (JP); Yoshie Yagi, Tokyo (JP)

Correspondence Address: SUGHRUE MION, PLLC, 2100 PENNSYLVANIA AVENUE, N.W., SUITE 800, WASHINGTON, DC, 20037, US

(73) Assignee: NEC Corporation, Tokyo (JP)

(21) Appl. No.: 12/432,520

(22) Filed: Apr. 29, 2009

Related U.S. Application Data
(62) Division of application No. 10/507,562, filed on Sep. 13, 2004.

(30) Foreign Application Priority Data
Mar. 14, 2002 (JP) 2002-070963

(51) Int. Cl. G02F 1/13357; G02F 1/1335; G02F 1/13

(52) U.S. Cl. 349/65; 349/67; 349/187

(57) ABSTRACT

The present invention relates to an optical modulating display device (200) such as a liquid crystal displaying device provided with a front-light type planar illuminating device.

The above front-light type planar illuminating device allows illuminating light to propagate inside a substrate (1), and is provided with a low refraction layer (3) being lower in refractive index than the substrate (1) and being in close contact with the inner surface of the substrate (1), and with reflection structure (11) on the outer surface of the substrate (1).

The optical modulating display device (200) provided with the above front-light type planar illuminating device can ensure a sufficient amount of guide light propagating inside the substrate (1) and reduce non-uniformity in display illumination.

And a display apparatus mounting the above optical modulating display device (200) thereon can be reduced in thickness and weight and provide a high quality display.

This is a divisional of application Ser. No. 10/507,562 filed Sep. 13, 2004, which is a National Stage Entry of PCT Application No. PCT/JP03/03025 filed Mar. 13, 2003, which claims the priority of Japanese Patent Application No. 2002-070963, filed Mar. 14, 2002. The entire disclosures of the prior applications are considered part of the disclosure of the accompanying divisional application and are hereby incorporated by reference.

### TECHNICAL FIELD

The present invention relates to an optical modulating display device provided with a planar illuminating system for illuminating a displaying device, a production method therefor and a display apparatus mounting the optical modulating display device thereon.

### BACKGROUND OF THE ART

A reflective liquid crystal displaying device is widely used for a display of an electronic apparatus such as a cellular phone and a personal digital assistant of which a main power supply is a battery. The reflective liquid crystal displaying device, however, uses an ambient external light, therefore when ambient light is poor like in night time, display is not easy to be seen or cannot be seen. Consequently, in these years, the reflective liquid crystal displaying device is provided with a front light for illuminating from an observer's side, whereby the front light is put the light on in order to make it easy to see the display even in an environment such as in the dark where the ambient light is poor. A technique is known which uses the ambient light for normal display and which illuminates from a rear of a semi-transparent liquid crystal displaying device in the case of poor ambient light thereby making it easy to see the display.

Also, an electronic paper has been developed as a display medium taken over from paper. The electronic papers using a cholesteric liquid crystal or taking advantage of electrophoretic migration have been developed.

However, if a liquid crystal displaying device is provided with a front light on the outside thereof, a depth feel corresponding to thickness of the front light occurs on a display, thereby resulting in deterioration in quality level of display. As a solution for this problem, a structure is known in which optical guiding function of the front light is given to a transparent substrate at an observer's side of the liquid crystal displaying device. A typical example of this structure is disclosed in, for instance, Japanese Laid-Open Patent Publication No. 2001-215509 (first prior art). FIG. 1 is a cross-sectional view illustrating a constitution of a liquid crystal displaying device in the first prior art.

A conventional liquid crystal device includes a laminated structure comprising an observer's side polarizer 35a, an observer's side transparent substrate 31, a transparent electrode 32, a liquid crystal layer 36, a transparent electrode 33, a rear transparent substrate 34, a rear polarizer 35b, and a reflective layer 37 and a light source 38 extending along a side portion of the observer's side transparent substrate 31. In the first prior art, microscopic concavity and convexity are formed on an observer's side surface of the observer's side transparent substrate 31, whereby the optical guiding function of the front light is given to the observer's side transparent substrate 31. Such a structure eliminates thickness of the front light, thereby allowing the above-described problem of deterioration in quality level of display to be overcome.

In the first prior art, however, the transparent electrode 32 is in direct contact with a lower part of the observer's side transparent substrate 31. The transparent electrode used in the liquid crystal displaying device is normally composed of ITO (Indium Tin Oxide). A refractive index of the transparent electrode composed of ITO depends on its film forming method, however generally the refractive index is approximately 1.7 to 2.0. Specifically, in the case of forming a film through a vapor deposition technique, the refractive index is approximately 1.7. In the case of forming the film through an ion plating technique, the refractive index is approximately 1.8 to 1.9. In the case of forming the film through a sputtering technique, the refractive index is approximately 1.9 to 2.0. Namely, in the case of forming the film of the transparent electrode through any film forming techniques, the refractive index (approximately 1.7 to 2.0) of the transparent electrode is higher than the refractive index (about n=1.5) of the transparent substrate. Light entering from a side face of the transparent substrate, therefore, does not cause total reflection on a boundary surface between the transparent substrate and the transparent electrode, almost all of the incoming light outgoes to a liquid crystal layer 8 in the vicinity of the side face of a light incoming side. Thus, light guiding may not be sufficiently performed up to an opposite side face to the light incoming side which is a side face opposite to the side face of the transparent substrate into which the light enters. Almost all of the incoming light also concentrates in the vicinity of the light incoming side. Thus, display is bright at a position near the light incoming side, however the display gets darker as receding from the light incoming side, that is to say, as approaching the other light incoming side. Consequently, non-uniformity in display illumination is caused in a display surface.

A second prior art is disclosed in Japanese Laid-Open Patent Publication No. 2001-21883 (second prior art). In the second prior art, a polarizer, a retarder, a diffuser, a color filter, and a transparent electrode are arranged on the lower side of first substrate (a glass substrate) having concavity and convexity which function as a light guiding plate of a front light. Similar to the first prior art, however, refractive index of PVA (polyvinyl alcohol) which is generally used as a main component of the polarizer is 1.49 to 1.53, which is the same level as, or larger than, the refractive index of the glass substrate, therefore the light entering into the substrate may not perform sufficient light guiding up to the opposite side face to the light incoming side.

An electronic paper has been further developed in various methods, however, a type such as the above reflective liquid crystal displaying device which has an external light source is not generally known, in the case of poor ambient light such as in the night time, display on the electronic paper is not easy to be seen or cannot be seen. The electronic paper is provided with the front light in the first prior art or the second prior art to allow the problems arising in the case of the poor ambient light to be overcome, however the other problems caused by providing with the front light cannot be solved.

### DISCLOSURE OF THE INVENTION

An object of the present invention is to provide an optical modulating display device allowing problems and defects associated with the prior arts to be solved.

Further object of the present invention is to provide an optical modulating display device which ensures an amount of guide light for performing sufficient light guiding of an incoming light up to an opposite side face to light incoming side and which achieves reduction of non-uniformity in display illumination in the optical modulating display device given a light guiding function to a substrate sandwiching an optical modulating layer.

Further object of the present invention is to provide a production method for an optical modulating display device allowing problems and defects associated with the above prior arts to be solved.

Further object of the present invention is to provide a production method for an optical modulating display device which ensuring an amount of guide light for performing sufficient light guiding an incoming light up to an opposite side face to light incoming side and which achieves reduction of non-uniformity in display illumination in the optical modulating display device given a light guiding function to a substrate sandwiching an optical modulating layer.

Further object of the present invention is to provide a liquid crystal displaying device allowing problems and defects associated with the above prior arts to be solved.

Further object of the present invention is to provide a production method for a liquid crystal displaying device which ensures an amount of guide light for performing sufficient light guiding of an incoming light up to an opposite side face to light incoming side and which achieves reduction of non-uniformity in display illumination in the optical modulating display device given a light guiding function to a substrate sandwiching an optical modulating layer.

First embodiment of the present invention provides an optical modulating display device, including a multilayer structure containing an optical modulating layer and a pair of first and second substrates sandwiching the multilayer structure, wherein

at least the first substrate is constituted so that light propagates therein,

the multilayer structure is constituted so that a boundary surface between the first substrate and the low refraction layer causes total reflection of the light incoming into the boundary surface in an oblique direction by including a low refraction layer being lower in refractive index than the first substrate and being in direct contact with the first substrate.

Preferably, a refractive index (nL) of the low refraction layer and a refractive index (nl) of the first substrate meet conditions given by nL−nl<−0.01.

The optical modulating layer may be constituted of a liquid crystal layer.

The optical modulating display device further includes a reflection structure for reflecting at an angle perpendicular to, or nearly perpendicular to, the boundary surface at least a part of the light incoming in an oblique direction from the first substrate at an opposite side to the low refraction layer with reference to the first substrate.

The reflection structure comprises a layered structure having at least either of a plurality of protrusions or a plurality of grooves at an opposite side to the first substrate.

At least either of the plurality of the protrusions or the plurality of the grooves preferably exist in almost the same region as a displaying region of the optical modulating display device.

The low refraction layer may be composed of a transparent material.

The low refraction layer may be composed of SiO₂ or MgF.

The optical modulating layer comprises a liquid crystal layer and the multilayer structure may be constituted so as to further include a polarizing layer, where only specific polarized light transmits, between the low refraction layer and the liquid crystal layer.

The optical modulating layer comprises a liquid crystal layer, the multilayer structure may be constituted so as to further include a plurality of color polarizing layer transmitting only specific polarized light of different specific wavelength band and being spatially arranged within each pixel region between the low refraction layer and the liquid crystal layer.

The optical modulating layer comprises a liquid crystal layer and the multilayer structure may be constituted so as to include a polarizing layer transmitting only specific polarized light and at least one or more phase difference layer between the low refraction layer and the liquid crystal layer.

The optical modulating layer comprises a liquid crystal layer, the multilayer structure may be constituted so as to include a plurality of color polarizing layer transmitting only specific polarized light of different specific wavelength band and being spatially arranged within each pixel region, and at least one or more phase difference layer between the low refraction layer and the liquid crystal layer.

The optical modulating layer comprises a liquid crystal layer and the multilayer structure may be constituted so as to include a laminated body laminated with a color filter layer transmitting light of different specific wavelength band, a polarizing layer transmitting only specific polarized light, and at least one or more phase difference layer in this order between the low refraction layer and the liquid crystal layer.

Preferably, a light source is arranged in the vicinity of first side end of the first substrate and the first side end is protruded outside compared with a side end of second substrate.

The optical modulating layer comprises a liquid layer and the multilayer structure may be constituted so as to further include a seal member provided in a peripheral region of the liquid crystal layer included in the multilayer structure and a light blocking layer adjusted so as to overlap the seal member viewed from a direction perpendicular to the boundary surface in order to attach the pair of first and second substrates.

The optical modulating layer comprises a liquid crystal layer and the multilayer structure may be constituted so as to further include a seal member provided for attaching the pair of the first and second substrates in a peripheral region of a laminated body in which a color filter layer transmitting light of different specific wavelength band, a polarizing layer transmitting only specific polarized light, and at least one or more phase difference layer are laminated in this order between the low refraction layer and the liquid crystal layer.

The optical modulating layer comprises a liquid crystal layer and a light source is provided in the vicinity of the first side end of the first substrate, a liquid crystal inlet used when injecting a liquid crystal material between the pair of the first and second substrates is provided at a side of the liquid crystal layer different from the first side end.

Second embodiment of the present invention provides an optical modulating display device including a multilayer structure containing an optical modulating layer and an optical propagating region constituted so that refractive index is uniform and that light propagates therein, wherein

the multilayer structure is constituted so that a boundary surface between the optical propagating region and the low refraction layer causes total reflection of the light incoming into the boundary surface in an oblique direction by including a low refraction layer being lower in refractive index than the optical propagating region and being in direct contact with the optical propagating region.

A refractive index (nL) of the low refraction layer and a refractive index (nl) of the optical propagating region preferably meet a condition given by nL−nl<0.01.

A reflection structure is preferably further included, wherein at least a part of light incoming in an oblique direction from the optical propagating region is reflected at an angle perpendicular to, or nearly perpendicular to, the boundary surface at an opposite side to the low refraction layer with reference to the optical propagating region.

The reflection structure may be constituted of a layered structure having at least either of a plurality of protrusions or a plurality of grooves at an opposite side of the first substrate.

The low refraction layer may be constituted of a transparent material.

The optical propagating region may comprise a substrate constituted so that light propagates therein. The optical propagating region may be constituted so as to include the substrate constituted so that the light propagates therein, and a thin film inserted between the substrate and the low refraction layer and being the same in refractive index as the substrate. The substrate, for instance, corresponds to the first substrate in other embodiments of the present invention.

Third embodiment of the present invention provides a liquid crystal displaying device including at least: first and the second substrates forming a pair, wherein at least the first substrate is constituted so that light propagates therein; a light source provided in the vicinity of the first side end of the first substrate; a multilayer structure sandwiched between the first and second substrates, including a low refraction layer being lower in refractive index than the first substrate and further being in direct contact with the first substrate, a color filter layer transmitting light of different specific wavelength band, a polarizing layer transmitting only specific polarized light, and at least one or more phase difference layer; a reflection structure for reflecting at an angle perpendicular to, or nearly perpendicular to, the boundary surface at least a part of light incoming in an oblique direction from the first substrate at an opposite side to the low refraction layer with reference to the first layer: wherein a boundary surface between the first substrate and the low refraction layer causes total reflection of the light incoming into the boundary surface in an oblique direction.

A refractive index (nL) of the low refraction layer and a refractive index (nl) of the first substrate preferably meet a condition given by nL−nl<−0.01.

The reflection structure may be constituted a layered structure having at least either of a plurality of protrusions or a plurality of grooves at an opposite side to the first substrate.

At least either of a plurality of the protrusions or a plurality of the grooves preferably exists in the nearly same region as a displaying region of the optical modulating display device.

The low refraction layer may be composed of a transparent material.

The low refraction layer may be composed of SiO₂ or MgF.

The first side end of the first substrate is preferably protruded outside compared with a side end of the second substrate.

The multilayer structure may be constituted so as to further include a seal member provided for attaching the pair of the first and second substrates in a peripheral region of a liquid crystal layer included in the multilayer structure and a light blocking layer adjusted so as to overlap the seal member viewed from a direction perpendicular to the boundary surface.

The multilayer structure may be constituted so as to further include a seal member provided for attaching the pair of first and second substrates in a peripheral region of the color filter layer, the polarizing layer, and the phase difference layer as well as the liquid crystal layer.

A liquid crystal inlet used when injecting a liquid crystal material between the pair of first and second substrates is preferably provided at a side of the liquid crystal layer different from the first side end.

Fourth embodiment of the present invention provides a liquid crystal displaying device including at least: first and second substrates forming a pair, wherein at least the first substrate is constituted so that light propagates inside it; a light source provided in the vicinity of the first side end of the first substrate; a multilayer structure sandwiched between the first and second substrates, which includes at least a low refraction layer being lower in refractive index than the first substrate and being in direct contact with the first substrate, a plurality of color polarizing layers transmitting light of different specific wavelength band and being spatially arranged within each pixel region, at least one or more phase difference layer; a reflection structure for reflecting at an angle perpendicular to, or nearly perpendicular to, the boundary surface at least a part of light incoming in an oblique direction from the first substrate at an opposite side to the low refraction layer with reference to the first layer: wherein a boundary surface between the first substrate and the low refraction layer causes total reflection of the light incoming into the boundary surface in an oblique direction.

A refractive index (nL) of the low refraction layer and a refractive index (nl) of the refractive index (nl) of the first substrate preferably meet a condition given by nL−nl<−0.01.

The reflection structure may be constituted of a layered structure having at least either of a plurality of protrusions or a plurality of grooves at an opposite side to the first substrate.

At least either of a plurality of the protrusions or a plurality of the grooves preferably exist in the nearly same region as a displaying region of the optical modulating display device.

The low refraction layer may be composed of a transparent material.

The low refraction layer may be composed of SiO₂ or MgF.

The first side end of the first substrate is preferably protruded outside compared with the side end of the second substrate.

The multilayer structure may be constituted so as to further include a seal member provided for attaching the pair of the first and the second substrates in a peripheral region of a liquid crystal layer included in the multilayer structure and a light blocking layer adjusted so as to overlap the seal member viewed from a direction perpendicular to the boundary surface.

The multilayer structure may be constituted so as to further include a seal member provided so as to attach the pair of first and second substrates in a peripheral region of the color polarizing layer and the phase difference layer as well as the liquid crystal layer.

A liquid crystal inlet used when injecting a liquid crystal material between the pair of first and second substrates is preferably provided at a side of the liquid crystal layer different from the first side end.

Fifth embodiment of the present invention provides an optical modulating display device including at least: a first and second substrates forming a pair, wherein at least the first substrate is constituted so that light propagates inside the substrate; a light source provided in the vicinity of the first side end of the first substrate; a multilayer structure sandwiched between the first and the second substrates, which includes a low refraction layer being lower in refractive index than the first substrate and further being in direct contact with the first substrate, a first transparent electrode layer, a first insulating layer, a charged fine particle filled layer filled with charged fine particles, and a second insulative layer, as well as a second transparent electrode layer; a reflection structure for reflecting at an angle perpendicular to, or nearly perpendicular to, the boundary surface at least a part of light incoming in an oblique direction from the first substrate at an opposite side to the low refraction layer with reference to the first layer; wherein a boundary surface between the first substrate and the low refraction layer causes total reflection of the light incoming into the boundary surface in an oblique direction.

A refractive index (nL) of the low refraction layer and a refractive index (nl) of the first substrate preferably meet a condition given by nL−nl<−0.01.

The reflection structure may be constituted a layered structure having at least either of a plurality of protrusions or a plurality of grooves at an opposite side to the first substrate.

Preferably, at least either of a plurality of the protrusions or a plurality of the grooves exist in the nearly same region as a displaying region of the optical modulating display device.

The low refraction layer may be composed of a transparent material.

The low refraction layer may be composed of SiO₂ or MgF.

Sixth embodiment of the present invention provides a production method for an optical modulating display device, wherein the method comprises the steps of:

manufacturing an optical modulating device including a first substrate constituted so that light propagates inside the substrate; a second substrate forming a counterpart to the first substrate, and a multilayer structure sandwiched between the first and second substrates which contains an optical modulating layer and a low refraction layer being in contact with the first substrate and comprising a material lower in refractive index than the first substrate; and

then, forming a reflection structure for reflecting at an angle perpendicular to, or nearly perpendicular to, the boundary surface at least a part of light incoming in an oblique direction from the first substrate at an opposite side to the low refraction layer with reference to the first substrate in the optical modulating device.

The step of forming the reflection structure further comprises the steps of:

applying a UV curing transparent resin on the opposite side of the first substrate; and

pressing a metal mold having at least either of a plurality of protrusions or a plurality of grooves on the UV curing transparent resin, and while pressing, introducing ultraviolet ray into the first substrate from the first side end of the first substrate, followed by hardening the UV curing transparent resin; and thereby printing the shape of the metal mold on the UV curing transparent resin.

The step of forming the reflection structure further comprises the steps of:

forming a transparent resin sheet at the opposite side of the first substrate;

pressing the metal mold having at least either of a plurality of protrusions or a plurality of grooves on the transparent resin and applying pressure on it; and while pressing, heating the transparent resin sheet up to a temperature of a glass transition point or higher of the transparent resin sheet, followed by printing the shape of the metal mold on the transparent resin sheet;

cooling down the transparent resin sheet up to room temperature while continuing to apply the pressure thereon; and

striping off the metal mold from the transparent resin sheet.

The step of forming the reflection structure is further followed by a step of dividing the optical modulating display device into a plurality of individual optical modulating display devices.

The step of manufacturing the optical modulating device comprises a step of assembling the pair of first and second substrates, and further comprises a step of previously creating a score at a side of the optical modulating layer in at least one of the first or the second substrate prior to the step of assembling.

Seventh embodiment of the present invention provides a production method for a liquid crystal displaying device, wherein the method comprises the steps of:

manufacturing a liquid crystal displaying device including a first substrate constituted so that light propagates inside the substrate, a second substrate forming a counterpart to the first substrate, and a multilayer structure sandwiched between the first and second substrates which includes a liquid crystal layer and a low refraction layer being in contact with the first substrate and comprising a material lower in refractive index than the first substrate; and

then, forming a reflection structure for reflecting at an angle perpendicular to, or nearly perpendicular to, the boundary surface at least a part of light incoming in an oblique direction from the first substrate at an opposite side to the low refraction layer with reference to the first substrate in the liquid crystal device.

The step of forming the reflection structure further comprises the steps of:

applying a UV curing transparent resin on the opposite side of the first substrate; and

pressing a metal mold having at least either of a plurality of protrusions or a plurality of grooves on the UV curing transparent resin, and while pressing, introducing ultraviolet ray into the first substrate from a first side end of the first substrate; followed by hardening the UV curing transparent resin, and thereby printing the shape of the metal mold on the UV curing transparent resin.

The step of forming the reflection structure further comprises the steps of:

forming a transparent resin sheet at the opposite side of the first substrate;

pressing the metal mold having at least either of a plurality of protrusions or a plurality of grooves on the transparent resin and applying pressure thereon, and while pressing, heating the transparent resin sheet up to a temperature a glass transition point or higher of the transparent resin sheet, and followed by printing the shape of the metal mold on the transparent resin sheet;

cooling down the transparent resin sheet up to room temperature while continuing to apply the pressure thereon; and

striping off the metal mold from the transparent resin sheet.

The step of forming the reflection structure is further followed by the step of dividing the liquid crystal displaying device into a plurality of individual liquid crystal displaying device.

The step of manufacturing the liquid crystal device comprises a step of assembling the pair of first and second substrates, and further comprises a step of previously creating a score at a side of the liquid crystal layer in at least either of the first or second substrate prior to the step of assembling.

As described above, the present invention provides an optical modulating display device. The optical modulating display device includes an optical modulating layer and a pair of first and second substrates sandwiching the optical modulating layer, where the first substrate is constituted so that light propagates inside the substrate and the first substrate includes a low refraction layer lower in refractive index on a near side of the optical modulating layer than the first substrate.

In conventional optical modulating display devices, a patterned structure such as the above transparent electrode, polarizer, insulating film, or color filter was in contact with inside of a pair of first and second substrates sandwiching an optical modulating layer, namely with a surface near the optical modulating layer. A refractive index of the transparent electrode is 1.7 to 2.0. A refractive index of an insulating film composed of polycarbonate is 1.58. A refractive index of the color filter is 1.49 to 1.55. These refractive indexes are higher than, or almost consistent with, approximately 1.5 of the refractive index of the above substrate. Therefore, the light incoming from the transparent electrode side does not cause total reflection on the boundary surface with the substrate. When the patterned structure such as the color filter is in contact with the above substrate, scattering of light occurs between or on the patterns, which causes non-uniformity in display illumination as well as a faint display. These have been problems of the conventional optical modulating display device.

However, as the present invention, a low refraction layer lower in refractive index than the substrate is provided at an inside of the first substrate constituted so that light propagates inside the substrate, namely at a near side of an optical modulating layer, whereby the light incoming from the side face of the substrate causes total reflection on a boundary surface between the first substrate and the low refraction layer. Therefore, incoming light can propagate up to an opposite side face to the side face of the substrate where the light enters, namely an opposite side of light incoming side, thereby to ensure a sufficient amount of guide light.

Also, the low refraction layer being lower in refractive index than the substrate is composed of a transparent material and constituted so as to be in contact with the substrate on a smooth surface, thereby to eliminate non-uniformity in display illumination due to the scattering of light.

Even when at least any one of a transparent electrode, a directing film, an insulating film, and a color filter is further arranged, the incoming light causes total reflection on the boundary surface between the above substrate and the low refraction layer comprising the transparent material. Therefore, degrees of freedom of selection of material of the transparent electrode, the directing film, the insulating film, and the color filter expand, resulting in effect improving degrees of freedom of constitution of the optical modulating display device.

In addition, when thickness of the low refraction layer composed of the transparent material is thinner than a wavelength, attenuation of the incoming light due to evanescent wave on the boundary surface between the low refraction layer and the substrate occurs. To avoid occurrence of the attenuation of the incoming light, the thickness of the low refraction layer composed of the transparent material is desirably 800 nm or more. When the thickness of the low refraction layer is 800 nm or more, the thickness of the low refraction layer of a wavelength of visible light or larger is ensured in an entire range of the wavelength of the visible light, whereby the attenuation of the incoming light can be securely avoided.

Relationship between a refractive index (nL) of the low refraction layer being lower in refractive index than the first substrate and a refractive index (nl) of the first substrate preferably meets a condition of nL−nl<−0.01. Namely, conditions of |nL−nl|>0.01 and nL<nl are preferably satisfied.

Specific methods and results of simulation performed by inventors of the present invention using an optical modulating (liquid crystal) displaying device 300 having a constitution illustrated in FIG. 2 will be described below.

Namely, as illustrated in FIG. 2, a protruded portion 11 formed with concavity and convexity in a protruded shape in a given interval is provided on a surface 102 of an observer's side Z of a transparent substrate 1 of the observer's side 2 among a pair of substrates sandwiching a liquid crystal layer and a transparent material layer 3 having a flat surface is formed on a surface 101 of the inside of the transparent substrate 1, namely an opposite side to the observer's side Z. A liquid crystal layer 8 is further suitably provided on a surface of an opposite side to the transparent substrate 1 in the transparent material layer 3, and a light reflector 405 comprising a mirror and the like is provided on a surface of opposite side of the transparent material layer 3 in the liquid crystal layer 8.

Then, a light source 12 is provided on a first side end of the transparent substrate 1, and a light reflector 13 is arranged at a rear side of the light source 12. A first photo acceptance unit 120 is further provided on a second end of an opposite side to the first side end of the transparent substrate 1 and a second photo acceptance unit 130 is provided at a second end of the liquid crystal layer 8. The first photo acceptance unit 120 measures an amount of guide light which is quantity of light propagating through the transparent substrate 1, while the second photo acceptance unit 130 measures an amount of stray light transmitting through the liquid crystal layer 8.

The stray light is expressed by a dotted line in FIG. 2. The stray light means light entering into the liquid crystal layer 8 without reaching the light reflector 405 due to a large incoming angle, namely a large angle from a direction of normal line of the liquid crystal layer 8, that is to say, the light reaching an opposite side of light incoming side without reflecting on the light reflector 405, or the light reflected on the light reflector 405, and the light causing total reflection on the boundary surface between the liquid crystal layer 8 and the transparent material layer 3 to be trapped in the liquid crystal layer 8.

In the simulation, difference Δn of refractive index between a refractive index nl of the transparent substrate 1 and a refractive index nL of a member constituting the transparent material layer 3, namely A n=(refractive index nL of the transparent material layer 3)−(refractive index nl of the transparent substrate 1) is varied and the amount of guide light and the amount of stray light are measured and analyzed respectively. The result is shown in FIG. 3. The amount of guide light is expressed by ♦ and a solid line and the amount of stray light is expressed by □ and a dotted line.

Namely, as shown in FIG. 3, it is found that the amount of guide light drastically drops when the difference Δn of the refractive index is 0 or more. It is also found that the amount of stray light rapidly increases when the difference Δn of the refractive index is 0 or more.

In the above simulation, the liquid crystal layer is selected as a photochromatic layer, however, also in the case that, other photochromatic layer, for instance, a toner layer used in an electrophoresis technique is used as a light modulating layer, it is found that the amount of guide light drastically drops when the difference Δn of the refractive index is 0 or more, and that the amount of stray light rapidly increases when the difference Δn of the refractive index is 0 or more.

Therefore, it is found to be necessary to meet a condition that the difference Δn of the refractive index is less than 0, namely A n<0 in order to achieve the above object in the present invention.

On the other hand, even if the low refraction layer is actually formed inside the substrate, it is possible to cause error of approximately ±0.01 in the refractive index of the low refraction layer due to surface roughness and non-uniformity in density in the transparent material layer constituting the low refraction layer. When the error of approximately ±0.01 in refractive index is caused, the difference Δn between the refractive index (nl) of the substrate and the refractive index (nL) of the low refraction layer is defined so as to meet a condition given by Δn=nL−nl<−0.01, which enables the refractive index to be made lower than that of the substrate.

In consideration with the above results of the simulation and problems in formation of layers, by defining the relationship between the refractive index of the substrate and the refractive index of the low refraction layer as nL−nl<−0.01, even if error of approximately ±0.01 is caused in the refractive index of the low refraction layer, incoming light securely performs total reflection on the boundary surface between the substrate and the low refraction layer, whereby a sufficient amount of guide light may be ensured within the substrate.

Also, by defining the relationship between the refractive index of the substrate and the refractive index of the low refraction layer as nL−nl<0, even if error of approximately ±0.01 is caused in the refractive index of the low refraction layer, incoming light securely causes total reflection on the boundary surface between the substrate and the low refraction layer, whereby a sufficient amount of guide light may be ensured within the substrate.

Further, according to the present invention, a liquid crystal displaying device having the above constitution is provided, where the optical modulating layer comprises a liquid crystal layer, a first transparent substrate among a pair of the transparent substrates sandwiching the liquid crystal layer is constituted so that light propagates inside the substrate, and a surface facing the liquid crystal layer among the first transparent substrate is provided with a transparent material layer comprising the transparent material being lower in refractive index than one of the transparent substrate.

In a conventional liquid crystal displaying device, the inside of a pair of transparent substrates sandwiching a liquid crystal layer, namely the surface of a near side of the liquid crystal layer was in contact with a patterned structure such as the transparent electrode, polarizer, and color filter. The refractive indexes of the transparent electrode, the polarizer (refractive index: 1.49 to 1.53), and the color filter are higher than, or almost same as, the refractive index of the transparent substrate. Therefore, the light incoming from a side of the transparent substrate cannot cause total reflection on a boundary surface with the transparent surface. Further, if the patterned structure such as the color filter is in contact with the transparent substrate, scattering of light occurs between or on the patterns, which causes non-uniformity in display illumination as well as a faint display.

However, if a transparent material layer being lower in refractive index than the transparent substrate is provided inside the transparent substrate in the present invention, the light incoming from a first side of the transparent substrate performs total reflection on the boundary surface between the transparent substrate and the transparent material layer having the low refractive index. Thus, the incoming light can be propagated up to an opposite side to the light incoming side, namely the second side, which is an opposite side to the first side face into which the light enters, therefore sufficient a sufficient amount of guide light may be ensured.

The transparent material layer being lower in refractive index than the transparent substrate is in contact with the transparent substrate through a smooth surface. Thus, the non-uniformity in display illumination due to the scattering of light may be eliminated.

Further, even if any one of the transparent electrode, the polarizer, the directing film and the color filter is arranged inside the transparent material layer being lower in refractive index than the transparent substrate, light causes total reflection of light occurs on the boundary surface between the transparent substrate and the transparent material layer, therefore degrees of freedom of selection of material of the transparent electrode, the polarizer, the directing film, and the color filter expand and resulting in effect enhancing the degrees of freedom of constitution of the liquid crystal displaying device.

The present invention is further constituted so that the light propagates inside the substrate and protrusions and/or grooves are provided on the surface of the substrate opposite to the surface of the substrate where an optical modulating layer in this substrate exists. Namely, the protrusions and/or the grooves are provided on an upper portion of the substrate of an observer's side, namely the surface of the substrate of the observer's side, thereby allowing an angle outgoing into the optical modulating layer to be controlled. Therefore, outgoing into the optical modulating layer does not occur without occurrence of total reflection as prior art, whereby non-uniformity in display illumination may be reduced. Further, thickness of the light guiding plate in the conventional front light is eliminated, thereby allowing depth feel of the display to be eliminated and enabling a liquid crystal displaying device to be reduced in thickness and weight.

The low refraction layer being lower in refractive index than the substrate may be constituted of the material being lower in refractive index than the substrate and materials with high stability and reliablity among them are preferably used, for instance, SiO₂ or MgF is preferable.

According to the present invention, a polarizing layer which transmits only specific polarized light between the low refraction layer being lower in refractive index than the substrate and the liquid crystal layer may be formed. If the polarizing layer is arranged outside the substrate, namely surface side, non-polarized light from a light source enters into the liquid crystal layer, therefore black color may not be displayed. Also if the polarizing layer is provided directly on the lower part of the substrate, the refractive index of the polarizing layer is nearly consistent with the refractive index of the substrate, therefore total reflection cannot occur to cause non-uniformity in display illumination. Thus, the polarizing layer may be provided between the low refraction layer being lower in refractive index than the substrate and the liquid crystal layer. Such a constitution enables a non-polarized source light emerged from the substrate to be polarized into linear polarized light or circularly polarized light, thereby achieving secure display and reducing simultaneously non-uniformity in display illumination.

According to the present invention, a plurality of color polarizing layers which transmits only specific polarized light of different specific wavelength band between the low refraction layer being lower in refractive index than the substrate and the liquid crystal layer may be spatially arranged within 1 pixel. Thus, one layer simultaneously has a polarizing function and a color filter function, whereby the number of lamination of a laminated body arranged on a lower part of the substrate of the observer's side is allowed to be reduced and resulting in an effect on simplification in manufacturing process.

According to the present invention, at least one phase difference layer may be further arranged between the polarizing layer or the color polarizing layer and the liquid crystal layer. If at least one phase difference layer is arranged between the polarizing layer or the color polarizing layer and the liquid crystal layer, an optical compensation of the liquid crystal may be performed and thereby eliminating reverse of display and color heterogeneity in display.

Also according to the present invention, the optical modulating layer is constituted of the liquid crystal layer, wherein the liquid crystal layer is sandwiched between a pair of first and second substrates, the low refraction layer being lower in refractive index than the first substrate is provided between the first substrate and the liquid crystal layer, and a laminated structure comprising a color filter layer which transmits light of different specific wavelength band, the polarizing layer, at least one or more phase difference layer may be arranged between the low refraction layer and the liquid crystal layer. That is, the color filter layer, the polarizing layer and at least one or more phase difference layer may be arranged in this order from the first substrate side. Such arrangement and formation of the polarizing layer and the phase difference layer after process of forming a color filter layer having many exposure processes improves reliability of device as well as enables optical correction of the liquid crystal.

The present invention is characterized in that terminal surface of a side provided with a light source of the substrate constituted so that light propagates inside the substrate is protruded outside of the other substrate among the pair of substrates. As the present invention, one substrate terminal surface provided with the light source is protruded outside of the other substrate, thereby facilitating connection between the light source and the substrate inside which light propagates and improving optical usability.

As shown in FIG. 4, in the present invention, protrusions and/or grooves provided on the first substrate may exist in a nearly consistent region viewed in a plane against display region 500 of the optical modulating display device. This can reduce useless outgoing light into the optical modulating layer and improve optical usability and further scattering of the light resulting from the useless outgoing light is further curbed whereby visual quality of the displaying device may be improved. Also it is preferable in view of improving optical usability that width of the region provided with the protrusions and/or grooves in the substrate is nearly same as a width of outgoing light into the substrate in which the light propagates inside the substrate.

According to the present invention, as shown in FIG. 5, an optical modulating layer comprises a liquid crystal layer, and a light blocking layer may be provided on a seal material for attaching a pair of substrates constituting the optical modulating display device. Thus, outgoing light into the optical modulating layer scatters by the seal material and deterioration in visual quality can be prevented. The seal material may also generally be constituted of epoxy resin or acrylic resin. Therefore, same as the polarizing layer and the color filter layer, the seal material comprising the epoxy resin or acrylic resin has refractive index around 1.5 and is provided between the first substrate and the liquid crystal layer, and it is preferable in view of ensuring an amount of guide light that a low refraction layer being lower in refractive index than the first substrate exists on the seal material for attaching the pair of the substrates.

According to the present invention, as shown in FIG. 6, an optical modulating layer comprises a liquid crystal layer and the polarizing layer, the color polarizing layer, and the phase difference layer do not exist on the seal material for attaching the pair of substrates. Thus, peeling off of each layer constituting multilayer structure is curbed and thereby reliability may be improved.

According to the present invention, the optical modulating layer comprises the liquid crystal layer, and a liquid crystal inlet for injecting liquid crystal material between the pair of the substrates may be provided a side except the side provided with the light source in the first substrate constituted so that the light propagates inside the substrate. Thus, connection between the light source and the first substrate in which the light propagates inside the substrate becomes easy.

The present invention further provides a production method of an optical modulating display device, where after manufacturing an optical modulating device including an optical modulating layer, a pair of first and second substrates sandwiching the optical modulating layer, and a low refraction layer which exists between the first substrate and the optical modulating layer and which comprises a material being lower in refractive index than the first substrate, thereafter the protrusions and/or grooves are formed on an opposite side surface to the low refraction layer in the first substrate. When the protrusions and/or the grooves are provided on a surface of an observer's side of the first substrate before assembling the optical modulating display device, it is possible to be unable to fix the substrate or possible to damage the surface of the observer's side in production processes of the optical modulating device. However, according to the production method of the optical modulating display device in the present invention, conventional production processes for the optical modulating device may be applied, therefore the problems does not occur. Thus, reliability improves in the processes, and yield ratio improves.

The present invention also provides a production method for a liquid crystal displaying device, where a transparent material layer comprising a material being lower in refractive index than first transparent substrate constituted so that light propagates inside the substrate among a pair of first and second transparent substrates exist between the first transparent substrate and the liquid crystal layer and after manufacturing a liquid crystal device having a structure sandwiching the liquid crystal layer between the second transparent substrate and the transparent material layer, protrusions and/or grooves are formed on a surface of opposite side to the transparent material layer in the first transparent substrate. If the protrusions and/or grooves are provided on a surface of an observer's side of the first substrate before assembling the liquid crystal displaying device, it is possible to be unable to fix the substrate or possible to damage the surface of the observer's side. However, according to the production method of the liquid crystal displaying device in the present invention, conventional production processes for the liquid crystal device may be applied, therefore the problems does not occur. Thus, reliability improves in the processes, and yield ratio enhances.

The present invention further provides a production method for an optical modulating display device, where a low refraction layer comprising a material being lower in refractive index than the first substrate on a surface of the first substrate comprising a transparent material among a pair of first and second substrates exists between the first substrate and the optical modulating layer and after manufacturing an optical modulating device having a structure sandwiching the optical modulating layer between the low refraction layer and the second substrate, UV curing transparent resin is applied on a surface of opposite side to the low refraction layer in the first substrate, pressing a metal mold having the protrusions and/or grooves on the UV curing transparent resin, and while pressing, introducing ultraviolet ray into the first substrate from a side terminal surface of the first substrate, followed by hardening the UV curing transparent resin. According to the production method of the optical modulating display device in the present invention, the protrusions and/or grooves may be formed only in a process of performing UV curing, resulting in allowing time period of processes to be shortened and productivity of the optical modulating display device to be improved.

The present invention further provides a production method for an optical modulating display device, where a low refraction layer comprising a material being lower in refractive index than the first substrate on a surface of the first substrate among a pair of first and second substrates exists between the first substrate and the optical modulating layer and after manufacturing an optical modulating device having a structure sandwiching the optical modulating layer between the pair of substrates, the protrusions and/or grooves are formed on the opposite side surface to the low refraction layer in the first substrate, and then dividing the optical modulating device into a plurality of optical modulating display devices. Also in the present production method, reliability of processes improves and yield ratio enhances. Further, simultaneous formation of a plurality of optical modulating display devices enables reduction of production cost. Also preferably, before assembling a pair of substrates, a score is previously formed on an opposite side to the optical modulating layer on one of the substrates or both substrates, which facilitates division into a plurality of the optical modulating devices.

### BRIEF DESCRIPTION OF DRAWINGS

FIG. 1 is a cross-sectional view of a conventional reflective liquid crystal displaying device.

FIG. 2 is a cross-sectional view illustrating an example of a structure of a light guiding plate used in a simulation in the present invention.

FIG. 3 is a graph showing results obtained in the simulation in the present invention.

FIG. 4 is a top view of a displaying device illustrating relation between a display area and a region where protrusions exist, according to sixth embodiment of the present invention.

FIG. 5 is a cross-sectional view illustrating a liquid crystal displaying device according to ninth embodiment of the present invention.

FIG. 6 is a cross-sectional view of an optical modulating display device according to first embodiment of the present invention.

FIG. 7 is a cross-sectional view where a part of the optical modulating display device of FIG. 6 is enlarged.

FIG. 8 is a cross-sectional view of a liquid crystal displaying device according to second embodiment of the present invention.

FIG. 9 is a cross-sectional view where a part of the liquid crystal displaying device shown in FIG. 8 is enlarged.

FIG. 10A to 10F are views illustrating a production method of a liquid crystal display portion according to third embodiment of the present invention.

FIG. 11A to 11D are views illustrating a production method of a protruded portion of the liquid crystal display portion according to the third embodiment of the present invention.

FIG. 12 is a cross-sectional view illustrating the liquid crystal displaying device according to fourth embodiment of the present invention.

FIG. 13A to 13D are views illustrating a production method of the liquid crystal display portion according to fourth embodiment of the present invention.

FIG. 14 is a cross-sectional view illustrating the liquid crystal displaying device according to fifth embodiment of the present invention.

FIG. 15 is a cross-sectional view illustrating positional relationship of a polarizing layer, phase difference layer, and seal agent of the liquid crystal displaying device according to eighth embodiment of the present invention.

FIG. 16A to 16D are views illustrating a production method of the liquid crystal displaying device according to ninth embodiment of the present invention.

FIG. 17A to 17B are views illustrating a production method of the liquid crystal displaying device according to tenth embodiment of the present invention.

FIG. 18 is a front view of a display apparatus according to thirteenth embodiment of the present invention.

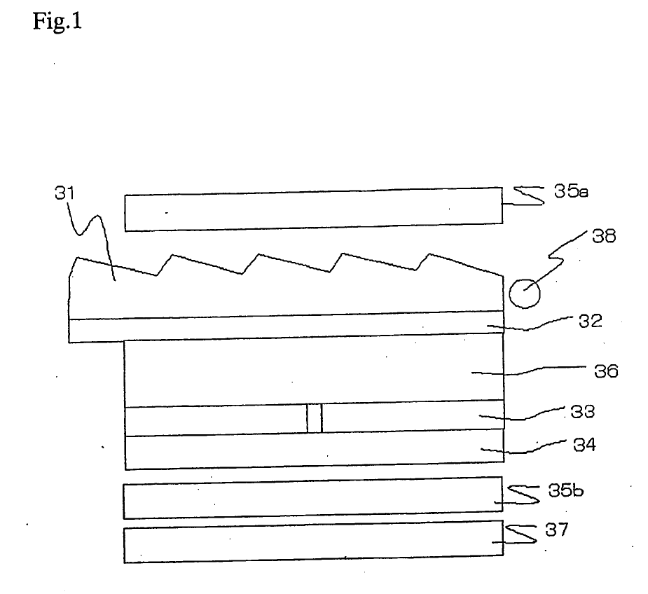

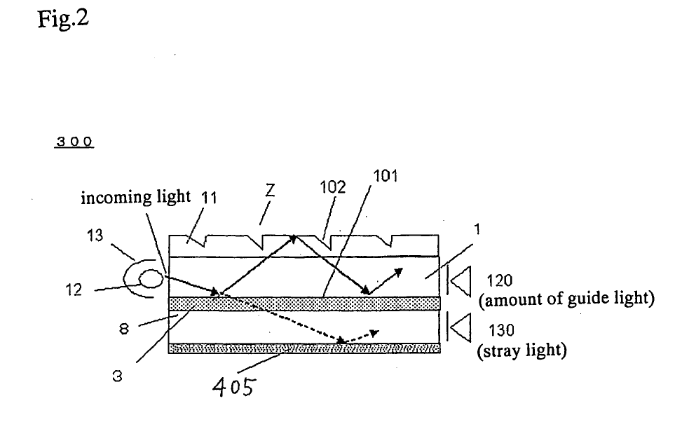

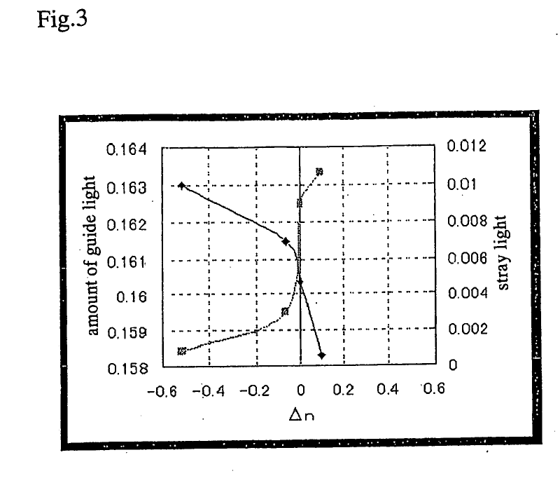

### BEST MODES FOR CARRYING OUT THE INVENTION

### First Embodiment

Embodiments of the present invention will be described below in reference to accompanied drawings in order to make clear objects, features and advantages of the present invention.

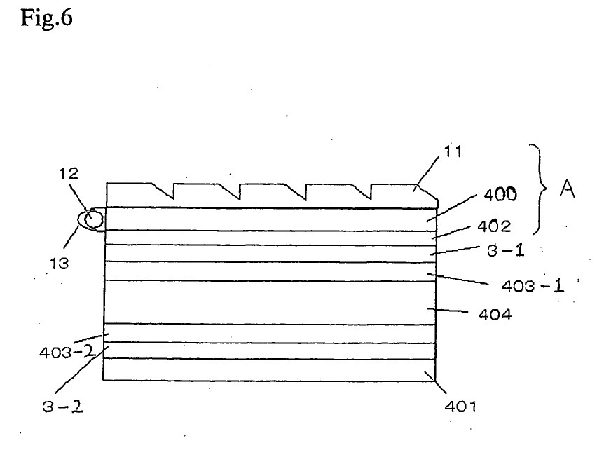

FIG. 6 is a cross-sectional view of an optical modulating display device according to first embodiment of the present invention. In the present embodiment, an optical modulating layer is constituted of a layer filled with charged fine particles. The optical modulating device in the present embodiment includes a pair of first substrate 400 and second substrate 401, a multilayer structure sandwiched between the first and second substrates 400 and 401. The multilayer structure has a structure in which a low refraction layer 402 being lower in refractive index than the first substrate 400, a first transparent electrode layer 3-1 for applying voltage, a first insulating layer 403-1, a charged fine particle filled layer 404 filled with the charged fine particle, a second insulating layer 403-2, and a second transparent electrode layer 3-2 for applying voltage are laminated, at least viewed from an observer's side, namely from an upper part of the drawing. The first substrate 400 is constituted of the transparent substrate so that light propagates inside the substrate. The charged fine particles include black charged fine particles with positive polarity and white charged fine particles with negative polarity.

Further, at least light source 12 and a reflector 13 for collecting light on a first side are arranged on the first side of the first substrate 400. Mirror finish is also applied on the first side of the first substrate 400 so as to remove flaw scattering light. A protruded portion 11 for reflecting the light incoming from the first side of the first substrate 400 in a direction where the charged fine particle filled layer 404 exists is further provided on a front surface of the first substrate 400, namely a surface of the observer's side. This protruded portion 11 comprises a protrusion flat portion 103a and a protrusion tilted portion 103b.

Difference Δn of the refractive index between a refractive index (nL) of the low refraction layer 402 being lower in refractive index than the first substrate 400 and a refractive index (nl) of the first substrate 400 is suitably set, thereby total reflection of the incoming light entering from the side of the first substrate 400 may occur on a border, namely a boundary surface, between the first substrate 400 and the low refraction layer 402.

In conventional optical modulating display devices, patterned structures such as a transparent electrode, directing film, or color filter are in contact with inside of a transparent substrate, however refractive indexes of the transparent electrode, the directing film, and color filter are higher than, or nearly same as, that of the transparent substrate, therefore total reflection of the light incoming from the transparent substrate side does not occur on the boundary surface between the transparent substrate and these patterned structures, and further when the patterned structures are in contact with the transparent substrate as the color filter, scattering occurs between and on the patterns, which causes non-uniformity in display illumination.

However, the above structure in the present invention enables sufficient light guiding of the incoming light up to an opposite side face of light-incoming side which is second side face opposite to the first side face of the transparent substrate constituting the first substrate 400 and enables non-uniformity in display illumination to be eliminated.

Also even when the first transparent electrode 3-1 and the first insulating layer 403-1 are arranged inside, namely within, the low refraction layer 402, however, total reflection of the incoming light occurs on the boundary surface between the first substrate 400 and the low refraction layer 402. Therefore, restriction on materials of the transparent electrode, the insulating layer etc. is eliminated and thereby degrees of freedom of constitution of the optical modulating display device enhances. Thickness of the low refraction layer 402 is desirably 800 nm or more.

By setting the thickness of the low refraction layer 402 as described above, the thickness becomes same as the wavelength or larger than that in an entire range of visible light wavelength, and attenuation of the incoming light due to evanescent wave may be eliminated on the boundary surface between the first substrate 400 and the low refraction layer 402.

In the optical modulating display device in the present invention, also the above constitution is adopted, therefore the thickness of the light guiding plate of front light is eliminated, which has been a problem of prior art, as a result, depth feel of display may be eliminated and effect on reduction in thickness and weight of the optical modulating display device is produced.

Display principle under an environment of poor external light such as night time will be described below in accordance with the present embodiment.

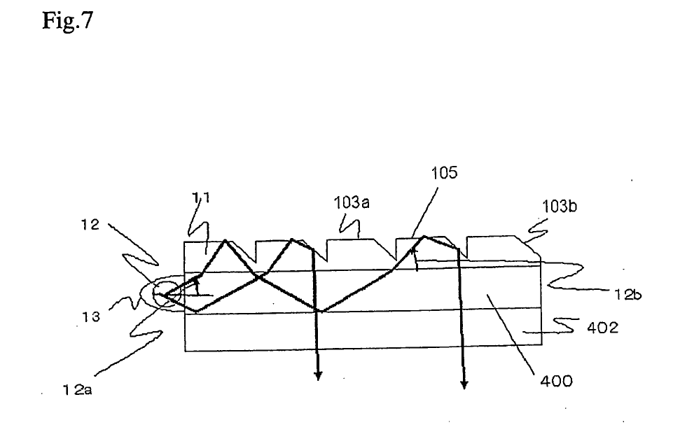

FIG. 7 is a cross-sectional view in which a part A of the optical modulating display device shown in FIG. 6 is enlarged. Light emerged from a light source 12 put light on enters into a first substrate 400 from a first side of the first substrate 400, and total reflection occurs on a border surface between a projection flat portion 103a and air. The incoming light of which total reflection has occurred is then refracted on the boundary surface between the first substrate 400 and a protruded portion 11, which reaches the boundary surface between a lower surface of the first substrate 400 (an opposite side surface to an observer's side) and a low refraction layer 402, total reflection of the incoming light occurs again on this boundary surface. The incoming light repeats total reflection and refraction and propagates to an entire surface within a display surface.

Light reaching a protrusion tilted portion 103b among propagating incoming light reflects to an angle different from a prior reflection angle, transmits the first substrate 400, a first and second transparent electrode layers 3-1, and 3-2 and a first and second insulating layers 403-1 and 403-2 and finally reaches a charged fine particle filled layer 404. Then, if voltage is applied between the first and second transparent electrodes 3-1 and 3-2 so as to charge negatively a first transparent electrode 3-1 positioning near an observer's side and so as to charge positively a second transparent electrode 3-2 positioning in far place from the observer's side, a black charged fine particles having positive polarity in the charged fine particle filled layer 404 moves to the observer's side. The light reaching the charged fine particle filled layer 404 is absorbed and black print becomes possible. Adversely, if voltage is applied between the first and second transparent electrodes 3-1 and 3-2 so as to charge negatively the first transparent electrode 3-1 positioning near the observer's side and so as to charge positively the second transparent electrode 3-2 in the far place from the observer's side, white charged fine particles having positive polarity in the charged fine particle filled layer 404 moves to the observer's side. The light reaching the charged fine particle filled layer 404 is absorbed and white print becomes possible. Contrasting of display and gradation sequence display depends on size and polarity of voltage applied between the first and the second transparent electrodes 3-1 and 3-2.

A first substrate 400, the protruded portion 11 and a low refraction layer 402 play a role substantially same as a light guiding function of a front light and enables display in a dark place.

The present specific example is a displaying device performing black and white presentation, however color display may be performed by providing a color filter layer.

Then, a preparing method of the present embodiment will be specifically described below.

At first, a UV curing material being lower in refractive index than a glass substrate, for instance, WR7709 with a refractive index of 1.38, which is produced by Kyouritsu Kagaku Co., was uniformly applied on the first substrate 400 comprising the glass substrate, hardened by exposing in ultraviolet ray to form a low refraction layer 402 having a uniform thickness of 2 μm or less and being lower in refractive index than the glass substrate. Then, a first transparent electrode layer 3-1 comprising ITO (Indium Tin Oxide) and so on was formed on the low refraction layer 402, for instance, formed through a sputtering technique. Polycarbonate resin was further applied on the first transparent electrode layer 3-1 to form a first insulating layer 403-1. A second transparent electrode layer 3-2 and a second insulating layer 403-2 were then formed on a second substrate 401 comprising the other glass substrate in a same manner as the above-described method.

Pearl resin of diameter of 20 μm to 25 μm containing white or black pigment was used as a charged fine particles. Titania powder was added on the sphere surface for controlling charge property as a white charged fine particles with positive polarity. Silica powder was added on the sphere surface for controlling the charge property as black charged fine particles with negative polarity. These white and black fine particles were mixed and stirred to charge both fine particles.

Then, a process of assembling a displaying portion will be described.

At first, in the previous process, the white charged fine particles and the black charged fine particles were sparged at a ratio of white:black=1:1 on one substrate among the two substrates in which the laminated structure was respectively formed. Then, an amount of sparging was adjusted so that filling ratio of these charged fine particles, specifically a ratio of sum of volumes of all fine particles to volume between the substrates is 20%. The both substrates were then attached to prepare the displaying portion. Distance between both substrates was 250 μm. The first substrate comprising the glass substrate positioned near the observer's side is protruded outside of the second substrate comprising an opposing glass substrate which makes it easy to arrange the light source.

Then, a process of preparing the protruded portion 11 will be described. A transparent resin sheet was arranged between a metal mold scattered with protrusions in a dotted form, of which cross-sectional shape is almost saw-tooth appearance, or a metal mold formed with the protrusions in a linear form and the displaying portion prepared prior to the present process. Pressure was then applied on the metal mold from above and the transparent resin sheet was pressed on the displaying portion. The transparent resin sheet was further heated up to a temperature of a glass transition point or higher to transform the transparent resin sheet into a protrusion shape using the metal mold as a template. After that, while continuing to apply the pressure thereon, the transparent resin sheet was cooled down up to room temperature, and thereafter the metal mold was striped off from the displaying portion. As a result, the protrusion shape of the metal mold was printed on the transparent resin sheet and the first substrate 400 comprising the glass substrate near the observer's side and the transparent resin sheet were in optically close contact with each other. Thus, the protruded portion 11 was formed on the first substrate 400.

Also in the above process, pressurization treatment in an atmosphere is assumed, however the pressurization treatment in vacuum may be performed. When the pressurization treatment in vacuum is carried out, air bubble is not printed on the transparent resin sheet, therefore the treatment is effective in improving yield ratio.

As described above, a first side of the first substrate comprising the glass substrate near the observer's side is protruded outside of the second substrate comprising an opposite side glass substrate. Therefore, after the just previously described process, a light emitting diode 12 as a light source emitting white light, a guide rod comprising a transparent material forming a source light into a linear source, and a reflector 13 was arranged on the first side of the first substrate. Also, the side of protruded glass substrate was polished precisely or the transparent resin layer was formed on the side thereby forming a mirror finished surface. The above structure in the present embodiment is completed through these processes.

In the present embodiment, the glass substrate was used as the pair of first and second substrates, however it is not necessary to be restricted to the glass substrate. For instance, a plastic substrate and so on may be used.

As described above, according to the present embodiment same as the embodiment, in the optical modulating display device, specifically in the liquid crystal displaying device, the low refraction layer being in contact with an inner surface of the substrate where illuminating light propagates and being lower in refractive index than the substrate is provided, thereby ensuring a sufficient amount of guide light propagating inside the substrate, reducing non-uniformity in display illumination, further reducing in thickness and weight of a display apparatus mounting these thereon to enable a high quality display.

### Second Embodiment

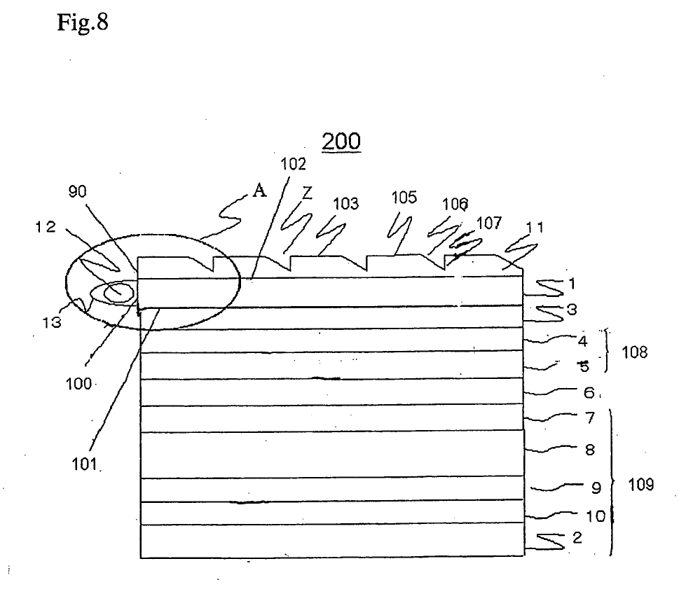

FIG. 8 is a cross-sectional view of an optical modulating display device according to second embodiment of the present invention. A liquid crystal displaying device in the present embodiment includes a multilayer structure containing a liquid crystal layer and a pair of first substrate 1 and second substrate 2 comprising transparent substrates sandwiching the multilayer structure. The multilayer structure is constituted of a laminated structure comprising, viewed from an observer's side, namely from an upper part of the drawing, a low refraction layer 3 being lower in refractive index than the transparent substrate and comprising a transparent material layer, a color filter layer 4 for color displaying, a polarizing layer 5 for transmitting only specific polarized light component, a phase difference layer 6 comprising at least one layer for performing an optical compensation of liquid crystal, a transparent electrode layer 7 for applying voltage thereon, a liquid crystal layer 8, and a reflective electrode layer 9 for reflecting incoming light in a direction of an observer, as well as a driving layer (active matrix device layer) 10 for driving the liquid crystal.

A light source 12 and a reflector 13 for collecting light emerged from the light source 12 on first side are arranged on the first side of the first substrate 1 comprising the transparent substrate. Mirror finish is also applied on the first side arranged with the light source 12 so as to remove flaw scattering the light. A protruded portion 11 for reflecting the light incoming from the first side of the first substrate 1 in a direction of the reflective electrode layer 9 is further provided on a front surface of the first substrate 1 comprising the transparent substrate, namely on a surface of the observer's side.

Difference Δn of the refractive index between a refractive index (nL) of the low refraction layer 3 being lower in refractive index than the first substrate 1 comprising the transparent substrate and a refractive index (nl) of the first substrate 1 is suitably set, thereby allowing total reflection of the incoming light entering from the first side of the first substrate 1 to occur on a border between the first substrate 1 and the low refraction layer 3, namely a boundary surface therebetween.

In a conventional optical modulating display device, patterned structures such as a transparent electrode, a directing film, or a color filter is in contact with inside of a transparent substrate, however refractive indexes of the transparent electrode, the directing film, and color filter are higher than, or nearly same as, refractive index of the transparent substrate, therefore total reflection of the light incoming from the transparent substrate side does not occur on the boundary surface between the transparent substrate and these patterned structures, and further when the patterned structure such as the color filter is in contact with the transparent substrate, scattering occurs between and on the patterns, which causes non-uniformity in display illumination.

Also, the above structure in the present invention enables sufficient light guiding of the incoming light up to an opposite side face to a light-incoming side which is the second side opposite to the first side of the transparent substrate constituting the first substrate 1 and also enables non-uniformity in display illumination to be eliminated.

The transparent electrode layer 7 and the color filter layer 4 are also arranged inside, namely within, the transparent material layer 3, however, total reflection of the incoming light occurs on the boundary surface between the first substrate 1 comprising the transparent substrate and the low refraction layer 3 comprising the transparent material layer. Therefore, restriction on materials of the transparent electrode, the directing film and the color filter is eliminated and degrees of freedom of constitution of the liquid crystal displaying device enhances. Thickness of the low refraction layer 3 comprising the transparent material layer is desirably 800 nm or more.

By setting the thickness of the low refraction layer 3 as described above, the thickness becomes same as or larger than the wavelength in an entire range of visible light wavelength, and attenuation of the incoming light due to evanescent wave may be eliminated on the boundary surface between the first substrate 1 and the low refraction layer 3.

In the liquid crystal displaying device in the present invention, also the above constitution is adopted, therefore the thickness of the light guiding plate of a front light is eliminated, which has been a problem of prior art, as a result, depth feel of display may be eliminated, which is effective in reducing in thickness and weight of a liquid crystal displaying device.

As described above, also in the example, the polarizing layer 5 for transmitting only at least specific polarized light between the low refraction layer 3 and the liquid crystal layer 8 was arranged so as not to be in direct contact with a lower part of the low refraction layer 3 comprising the transparent material layer.

In other words, the light emerged from the light source 12 is non-polarized light. In the case that the polarizing layer 5 is not provided between the first substrate 1 and the liquid crystal layer 8, the non-polarized light is entered into the liquid crystal layer 8. Therefore, normal display becomes difficult. Particularly, black display is difficult.

Even though the polarizing layer 5 is provided, in the case that the polarizing layer 5 is provided so as to be in direct contact with a lower part of the first substrate 1 comprising the transparent substrate functioning as a light guiding layer, a refractive index of the polarizing layer 5 is almost same as refractive index of the transparent substrate constituting the first substrate 1, therefore total reflection of the incoming light cannot occur on the boundary surface between the first substrate 1 and the polarizing layer 5, which causes non-uniformity in display illumination.

Thus, the polarizing layer 5 is preferably provided between the low refraction layer 3 and the liquid crystal layer 8 so as not to be in direct contact with the lower part of the low refraction layer 3. Such a structure allows the non-polarized source light emerged from the transparent substrate to polarize into linear polarized light or circularly polarized light, thereby to enable display to ensure and to simultaneously enable reduction of non-uniformity in display illumination.

The phase difference layer 6 is further arranged on the lower part of the polarizing layer 5, therefore an optical compensation of the liquid crystal may be performed and inversion of display and color irregularity may be eliminated.

Display principle under an environment of poor external light such as night time will be described below in accordance with the present embodiment.

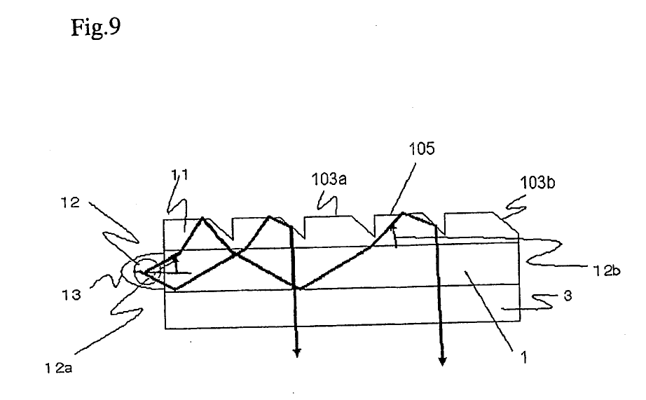

FIG. 9 is a cross-sectional view in which a part A of a liquid crystal displaying device shown in FIG. 8 is enlarged. Light emerged from a light source 12 put light on enters within a first substrate 1 from a first side of the first substrate 1, and total reflection of the light occurs on a border surface between projection flat portions 103a and air.

The incoming light of which the total reflection has occurred then refracts on a boundary surface between the first substrate 1 comprising a transparent substrate and a protruded portion 11, and reaches the boundary surface between a lower surface of the first substrate 1 (a surface of opposite side to an observer's side surface) comprising the transparent substrate and a low refraction layer 3, and thereafter total reflection of the incoming light occurs again on this boundary surface. The incoming light repeats the total reflection and refraction and propagates to an entire surface within a display surface.

Light reaching a protrusion tilted portion 103b among propagating incoming light reflects to an angle different from a prior reflection angle, and transmits the first substrate 1 comprising the transparent substrate. The transmitted light propagates to a color filter layer 4, a polarizing layer 5, a phase difference layer 6, and a liquid crystal layer 8, and reflects on a reflective electrode layer 9, and transmits again the liquid crystal layer 8, the phase difference layer 6, the polarizing layer 5, the color filter layer 4, a low refraction layer 3 comprising a transparent material layer, and the first substrate 1 comprising the transparent substrate as well as a protruded portion 11 to be recognized by an observer. Contrasting of display, gradation sequence display, and color display are controlled by voltage applied on liquid crystal.

In the present embodiment like this, a first substrate 1 comprising the transparent substrate, a protruded portion 11 and a first substrate 3 comprising the low refraction layer comprising the transparent material layer play a role substantially the same as a light guiding function of a front light and enables display in a dark place.

As a modified example of the above example, also in the present specific example, the low refraction layer 3 comprising the transparent material layer is provided so as to be in contact with the lower surface of the first substrate 1 comprising the transparent substrate. However, this low refraction layer 3 may be constituted of any one of the polarizing layer 5, the phase difference layer 6 or the transparent electrode layer 7. Namely, as a condition that any one of the polarizing layer 5, the phase difference layer 6 or the transparent electrode layer 7 is lower in refractive index than the first substrate 1 comprising the transparent substrate without being provided with the transparent material layer 3, this layer plays a role as the low refraction layer, whereby it is possible to constitute so that total reflection of an incoming light occurs on the boundary surface between the low refraction layer 3 constituted of any one of the polarizing layer 5, the phase difference layer 6 or the transparent electrode layer 7 and the first substrate 1 comprising the transparent substrate. Namely, such a constitution enables constitution so that any one of the polarizing layer 5, the phase difference layer 6, or the transparent electrode layer 7 combine function and action provided by a low refractive index of the transparent material layer 3 without using the transparent material layer 3.

As a further modified example of the present embodiment, the polarizing layer 5 and the color filter layer 4 may be replaced with at least one color polarizing layer transmitting only specific polarized light of different specific wavelength band. It is preferably to spatially arrange a plurality of the color polarizing layer within one pixel. Namely, the color polarizing layer is provided, whereby a single layer is in charge of a polarizing function and a color filter function. Therefore, the number of layers of a laminated body arranged between the first substrate 1 comprising the transparent substrate positioned at an observer's side and a liquid crystal layer 8 is reduced to be effective in simplification of a production process.

As described above, according to the present embodiment same as the above embodiment, in the optical modulating display device, specifically a liquid crystal displaying device, the low refraction layer being in contact with an inner surface of the substrate where illuminating light propagates and being lower in refractive index than the substrate is provided, thereby ensuring a sufficient amount of guide light propagating inside the substrate, reducing non-uniformity in display illumination, further reducing in thickness and weight of a display apparatus mounting these thereon to enable a high quality display.

### Third Embodiment

Then, a preparing method of the present embodiment will be specifically described below.

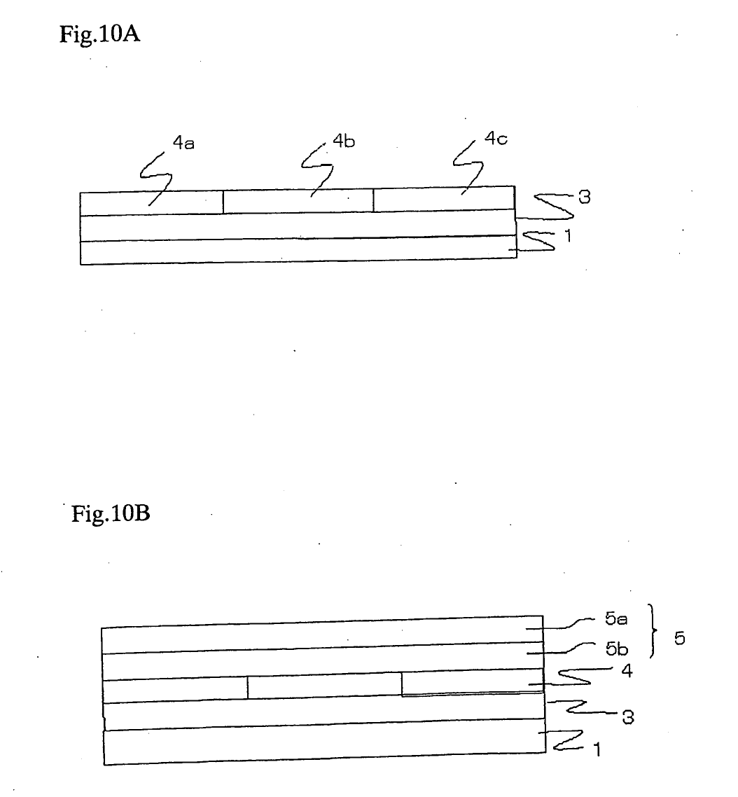

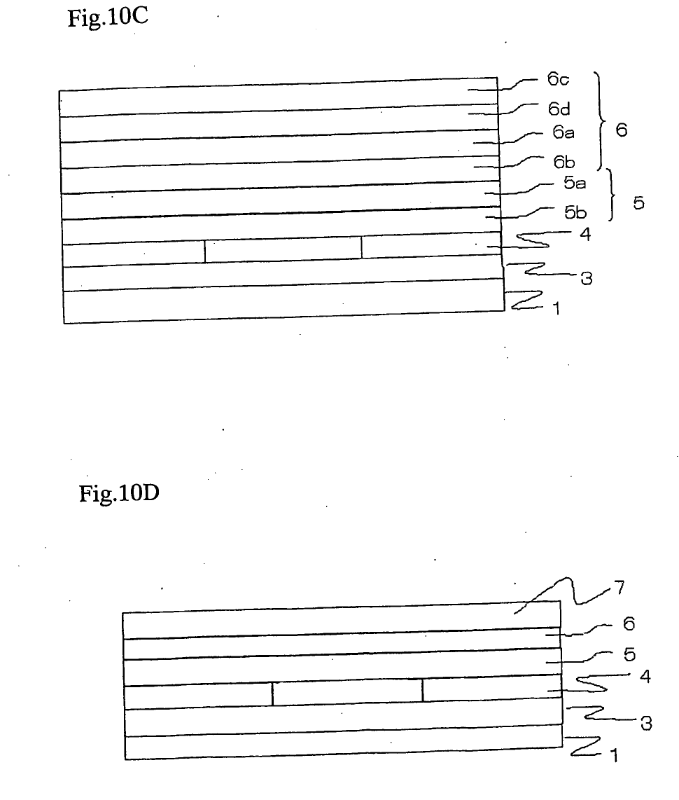

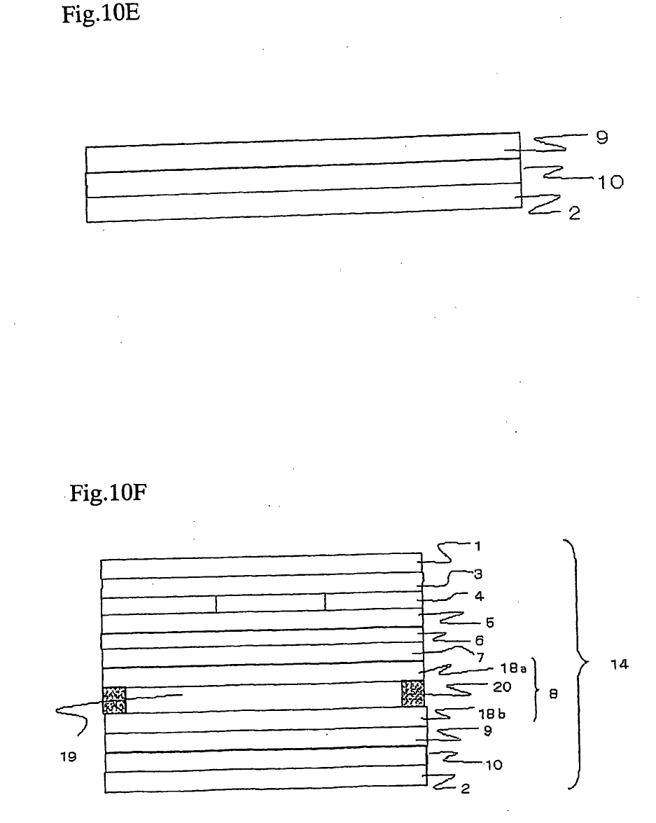

FIG. 10A to 10G are cross-sectional views illustrating a production method of an optical modulating (liquid crystal) displaying device in an embodiment according to the present invention, where FIG. 10A to 10C show manufacturing processes of a first glass substrate in a liquid crystal displaying device combining a light guiding function of a front light and FIG. 10D to 10F show manufacturing processes of a second glass substrate and assembling processes of a liquid crystal displaying portion. FIG. 10G also shows a manufacturing process of a protruded portion in the liquid crystal displaying device in the present invention. As a flow of schematic processes of production, the liquid crystal displaying portion 14 is first prepared and the protruded portion 11 is then formed on the liquid crystal displaying portion 14.

As illustrated in FIG. 10A, after uniformly applying a UV curing transparent material being lower in refractive index than the glass substrate 1 on the first transparent glass substrate 1, the material by performing ultraviolet ray exposure was hardened, followed by forming a low refraction layer 3 comprising the transparent material layer having even thickness of 2 μm or less. Then, a color resist of R (red) was applied on the low refraction layer 3 comprising the transparent material layer, followed by performing a pattern exposure, development, and fixing to form a red (R) layer 4a of a color filter. By performing the same operations, a G (green) layer 4b and a blue (B) layer 4c were formed and a color filter layer 4 spatially divided whose thickness is approximately 1 μm was formed. In the case that a surface of the formed color filter layer 4 is not smooth, an overcoat layer comprising a transparent resin was formed on the surface of the color filter layer 4 to make the surface smooth.

As illustrated in FIG. 10B, after forming a material with anisotropy in absorption, for instance, a directing layer 5b for directing a dichromatic pigment, on the color filter layer 4, a UV curing resin containing the dichromatic pigment was uniformly applied to perform a ultraviolet ray exposure. Thereby a UV curing resin layer 5a where the dichromatic pigment is in a uniaxial orientation was formed. The used dichromatic pigment is a mixture of dichromatic pigments absorbing cyan, magenta, yellow and so on, and this mixture absorbs almost entire range of visible light. Further the dichromatic pigment is in the uniaxial orientation, thereby occurring anisotropy in absorption of light to form a laminated body of the UV curing resin layer 5a in the uniaxial orientation and the directing layer 5b for directing the dichromatic pigment. The laminated body comprising the directing layers 5a and 5b play a role as a polarizing layer 5. Namely, the polarizing layer 5 in the present embodiment comprises a double layered structure of the directing layer 5b for directing the dichromatic pigment and the UV curing resin layer 5a containing the dichromatic pigment.

Processes shown in FIG. 10C, after applying and forming a directing layer 6b for directing liquid crystalline monomer on the UV curing resin layer 5a with the uniaxial orientation, the liquid crystalline monomer was hardened with ultraviolet ray, followed by forming a uniaxial anisotropic layer 6a of a birefringence amount of approximately 275 nm at a wavelength of 550 nm. An optical axis of the uniaxial anisotropic layer 6a depends on a orientating direction of the directing layer 6b, and the optical axis of the uniaxial anisotropic layer 6a is consistent with an axis rotated approximately 15 degrees in clockwise direction with reference to an absorbing axis of the polarizing layer 5.

By repeating operations same as the above operations, after applying and forming a directing layer 6c for directing the liquid crystalline monomer on the directing layer 6d, the liquid crystalline monomer was hardened with ultraviolet ray to form a uniaxial anisotropic layer 6c of birefringence amount of approximately 137 nm at a wavelength 550 nm. An optical axis of the uniaxial anisotropic layer 6c is consistent with an axis rotated about 75 degree in clockwise direction from the absorbing axis of the polarizing layer 5.

A phase difference layer 6 comprising these four layers, specifically the directing layer 6b, the uniaxial anisotropic layer 6a, the directing layer 6d and the uniaxial anisotropic layer 6c functions as a wide range quarter wave plate for converting linear polarized light emerged from the polarizing layer 5 into circularly polarized light almost over entire range of visible light.

In the present embodiment, the phase difference layer 6 including two uniaxial aniotropic layers 6a and 6c is used excluding the directing layers 6b and 6d, however it is not restricted to this, and the phase difference layer 6 may include a single uniaxial anisotropic layer. In this case, a direction of the optical axis and the birefringence among of the phase difference layer 6 are suitably adjusted.

As shown in FIG. 10D, a transparent electrode layer 7 comprising ITO (Indium Tin Oxide) and so on is formed on the phase difference layer 6 through a sputtering technique.

As shown in FIG. 10E, a driving layer 10 was formed which is arranged on an array with an active device for driving each pixel on the second glass substrate 2, and a reflective electrode layer 9 was further formed which comprises a metal reflective plate in concavity and convexity shape on the upper surface of the driving layer 10.

Assembling process of a liquid crystal display portion 14 will be described in reference to FIG. 10F. In the prior processes, the first and second substrates 1 and 2 having respectively the first and second multilayer structures were drafted. On the surface of the transparent electrode layer 7 in the first multilayer structure formed on the first substrate 1 shown in FIG. 10D, a first directing layer 18a for directing liquid crystal was formed. On the surface of the reflective electrode layer 9 in the second multilayer structure formed on the second substrate 1 shown in FIG. 10E, a second directing layer 18a for directing the liquid crystal was formed. A direction of orientation of the first directing layer 18a is a direction of approximately 35 degree in clockwise direction with reference to the absorbing axis of the polarizing layer 5 and a direction of orientation of the second directing layer 18b is a direction of approximately 37 degree in counterclockwise direction.

Then, a spacer (not shown) and seal agent 20 were sandwiched between both substrates 1 and 2, which were attached so as to make clearance of approx. 4 μm between both substrates 1 and 2. Liquid crystal 19 was finally injected into the clearance from an inlet, and the clearance was filled with the liquid crystal 19, thereafter the inlet was sealed to complete the liquid crystal displaying portion 14, where the liquid crystal layer 8 comprises the liquid crystal 19, the spacer and the seal agent 20, the first and second directing layers 18a and 18b sandwiching these.

In addition, a thing to be kept in mind is that, though it is not shown in drawings, a first glass substrate 1a of the liquid crystal displaying portion 14 is protruded outside of the second glass substrate 2a which facilitates arrangement of the light source 12.

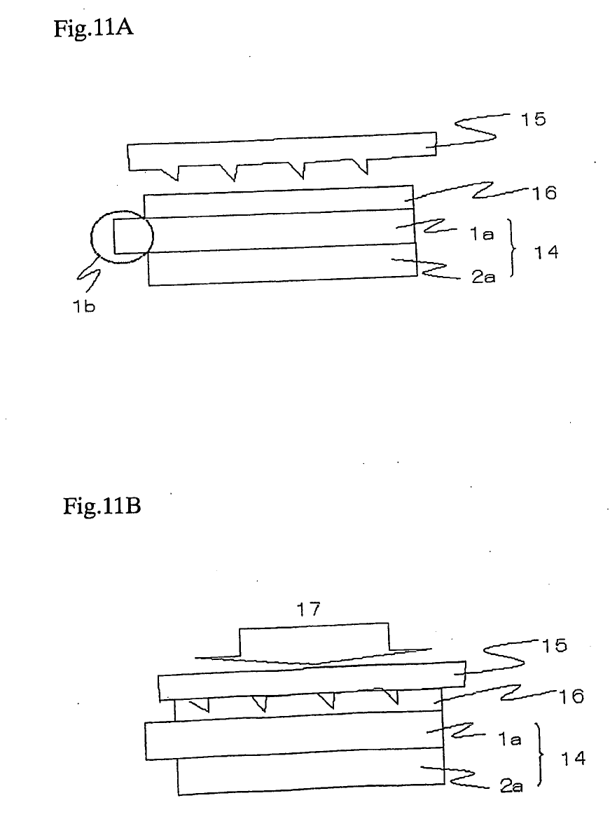

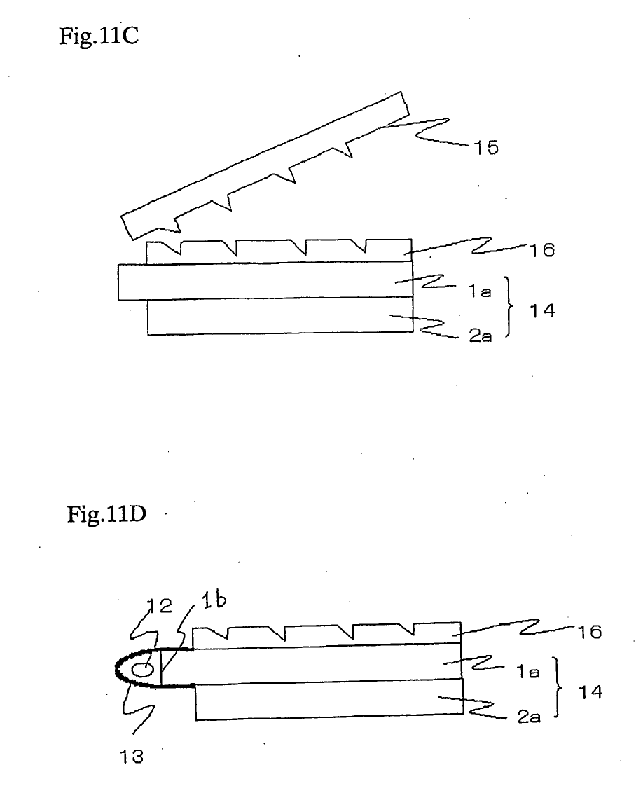

Preparing processes of the protruded portion 11 of the liquid crystal displaying device will be described in reference to FIG. 11A to 11D.

As shown in FIG. 11A, the liquid crystal displaying portion 14 prepared prior to the present process was arranged so as to position the first glass substrate 1a on the second glass substrate 1b. A metal mold 15 scattered with protrusions in a dotted form of which cross-sectional shape is nearly saw-tooth appearance or formed in a linear shape was prepared. A transparent resin sheet 16 was arranged between the liquid crystal displaying portion 14 and the metal mold 15, where the transparent resin sheet 16 is arranged on the first glass substrate 1a.

As shown in FIG. 11B, pressure 17 was applied toward the transparent resin sheet 16 from upper part of the metal mold 15, and the transparent resin sheet 16 was pressed on a surface of the liquid crystal displaying portion 14, namely on a surface of the first glass substrate 1a. Thereafter, the transparent resin sheet 16 was heated up to a temperature of glass transition point or higher, and was transformed into a protruded shape of the metal mold 15.

As shown in FIG. 11C, in a state that pressure 17 is being applied, the transparent resin sheet 16 was cooled down to room temperature, and then the metal mold 15 was striped off from the liquid crystal displaying portion 14, namely from the transparent resin sheet 16. As a result, on the surface of the transparent resin sheet 16, the protruded shape of the metal mold 15 was printed, and the first glass substrate 1a and the transparent resin sheet 16 are further in optically close contact with each other. Thereby, the protruded portion 11 was formed on the first glass substrate 1a.

In the case that the transparent resin sheet 16 and the first glass substrate 1a are not attached well, the transparent resin sheet 16 and the first glass substrate 1a are attached using an adhesive agent of which refractive index is almost consistent with that of the first glass substrate 1a, or an adhesive agent of which refractive index is almost consistent with that of the transparent resin sheet 16.

In the present embodiment, after liquid crystal 19 was injected into the liquid crystal displaying portion 14, the protruded portion 11 was formed. However, the protruded portion 11 may be formed before the liquid crystal is injected into the liquid crystal displaying portion 14.

Also, a pressurization treatment was performed in the atmosphere in the above process, however the pressurization treatment may be performed in vacuum. If the pressurization treatment is performed in vacuum, air bubble is not printed on the transparent resin sheet 16, thereby the treatment is effective in improving yield ratio.

As shown in FIG. 11D, a light emitting diode 12 for emitting white light, a guide rod (not shown) comprising the transparent material for forming source light into linear light source from the light emitting diode 12, and reflector 13 are arranged on the first side 1b of the first glass substrate 1a, namely a protruded portion outside of the second glass substrate 2a. Or instead of that, the first side 1b of the first glass substrate 1a is precisely polished, or the transparent resin layer (not shown) was formed on the first side 1b to form a mirror finished surface. Through the above series of processes shown in FIG. 10A to 10F and FIG. 11A to 11D, a structure of the liquid crystal displaying device according to the present embodiment is completed.

According to the present embodiment, the first and second glass substrates 1a and 2a were used as the first and second transparent substrates 1 and 2, however it is not necessary to be restricted to this, for instance, a transparent plastic substrate may be used as the first and second transparent substrates 1 and 2.

Also according to the present embodiment, at least viewed from an observer's side (from upper part of the drawing), a low refraction layer 3 comprising the transparent material layer, a color filter layer 4, a polarizing layer 5, a phase difference layer 6, a transparent electrode layer 7, liquid crystal layer 8, and a reflective electrode layer 9 as well as a driving layer 10 are laminated in this order. However, if the polarizing layer 5 exists at a position above the phase difference layer 6, namely at a closer position to the first transparent substrate 1, the same effect as the present embodiment is obtained. Therefore, as a modified example of the present embodiment, for instance, viewed from the observer's side (from the upper part of the drawing), the transparent material layer 3, the polarizing layer 5, the color filter layer 4, the phase difference layer 6, the transparent electrode layer 7, the liquid crystal layer 8, and the reflective electrode layer 9 as well as the driving layer 10 may be laminated in this order. Or as a further modified example of the present embodiment, for instance, viewed from the observer's side, the transparent material layer 3, the polarizing layer 5, the phase difference layer 6, the color filter layer 4, the transparent electrode layer 7, the liquid crystal layer 8, and the reflective electrode layer 9 as well as the driving layer 10 may be laminated in this order.

In addition, as a further modified example of the present embodiment, a metal lattice formed with a pitch of visible wavelength or lower may be used instead of the polarizing layer 5. A color filter of complementary color base, typically, Y (yellow), M (magenta), and C (cyan) may be used instead of the color filter layer 4.

As described above, according to the present embodiment same as the above embodiment, in the optical modulating display device, specifically the liquid crystal displaying device, the low refraction layer being in contact with the inner surface of the substrate inside which illuminating light propagates and being lower in refractive index than the substrate is provided, thereby ensuring a sufficient amount of guide light propagating inside the substrate and reducing non-uniformity in display illumination, and further reducing i thickness and weight of a display apparatus mounting these thereon to enable a high quality display.

### Fourth Embodiment

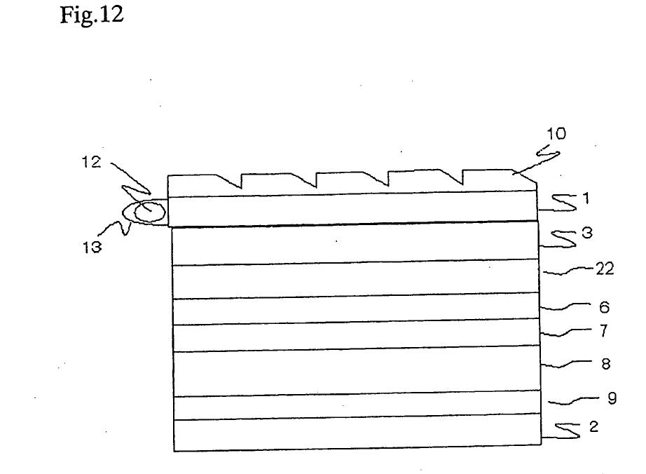

FIG. 12 is a cross-sectional view illustrating a liquid crystal displaying device according to fourth embodiment of the present invention. A structure of the liquid crystal displaying device according to the fourth embodiment shown in FIG. 12 is different in a point described below from the above structure of the liquid crystal displaying device according to the second embodiment shown in FIG. 8. In addition, in a constitution of the liquid crystal displaying device shown in FIG. 12, the same symbols as the symbols used in FIG. 8 are given to the same portions as the constitution according to the second embodiment shown in FIG. 8.

As seen in comparison of the structure shown in FIG. 12 with the structure shown in FIG. 8, in the structure of the liquid crystal displaying device according to the fourth embodiment shown in FIG. 12, a single color polarizing layer 22 having a polarizing function and a color displaying function together is provided instead of a polarizing layer 5 and a color filter layer 4 having the above structure of the liquid crystal displaying device according to the second embodiment shown in FIG. 8. Thereby, in addition to the effect described in the second embodiment, an effect of reducing the number of lamination and an effect on simplification of production process involved in this are obtained.

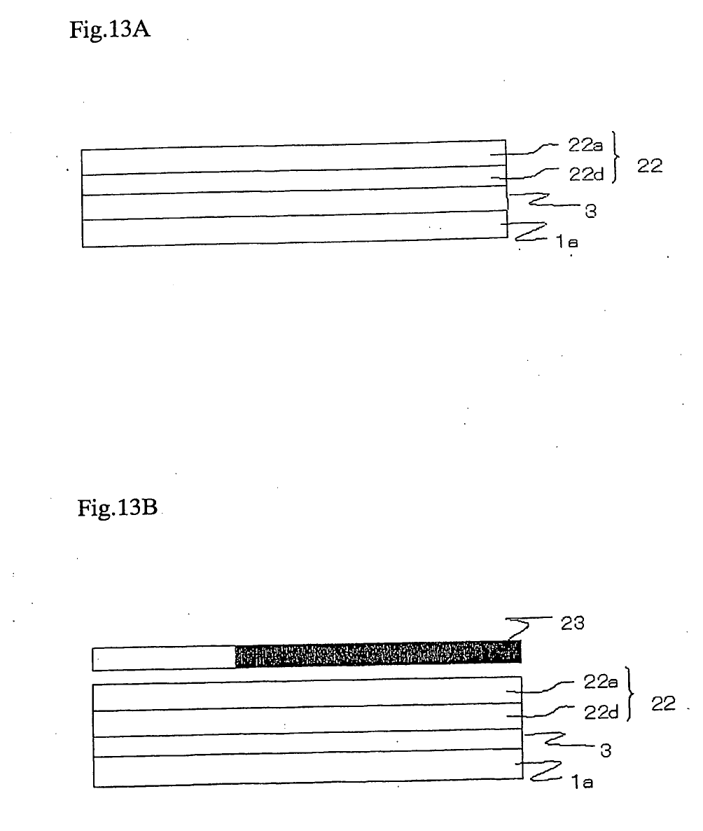

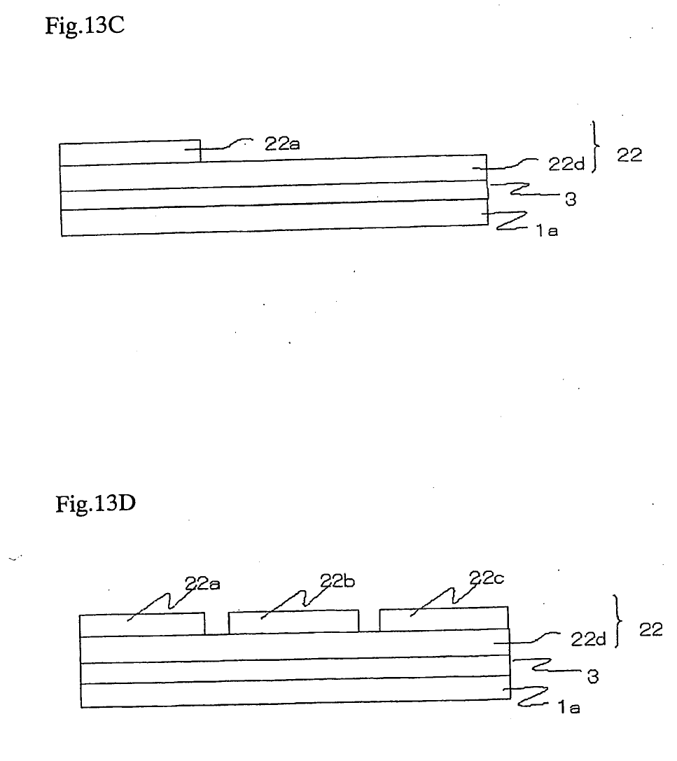

A part of production process of the liquid crystal displaying device according to the present embodiment is shown below in reference to FIG. 13A to 13D.

As shown in FIG. 13A, after uniformly applying a UV curing transparent material being lower in refractive index than a glass substrate 1a on the first transparent glass substrate 1a, the material was hardened by performing a ultraviolet ray exposure to form a low refraction layer 3 comprising the transparent material layer having even thickness of 2 μm or less.

Then, after forming a material with anisotropy in absorption, for instance, a directing layer 22d for directing a dichromatic pigment, on the low refraction layer 3 comprising the transparent material layer, a UV curing resin containing the dichromatic pigment was uniformly applied to perform the ultraviolet ray exposure. Thereby, a UV curing resin layer 22d where the dichromatic pigment is in a uniaxial orientation was formed. The used dichromatic pigment is a mixture of dichromatic pigments absorbing cyan, magenta, yellow and so on, and this mixture absorbs almost entire range of visible light.

Further liquid crystalline monomer mixture 22a with UV curing property containing the dichromatic pigment transmitting red light (R) was uniformly applied thereon.

As shown in FIG. 13B, after arranging a patterned mask 23 in a stripe shape above the substrate, the liquid crystalline monomer mixture 22a with UV curing property containing the dichromatic pigment was selectively exposed with ultraviolet ray using the patterned mask 23.

Then, as shown in FIG. 13C, the used patterned mask 23 was removed, portions which have not been exposed in the liquid crystalline monomer 22a were further removed through development to form a patterned red (R) color polarizing layer 22a.

As shown in FIG. 13D, after applying a liquid crystalline monomer mixture 22b containing the dichromatic pigment transmitting green light (G) on the red (R) color polarizing layer 22d, a patterned mask (not shown) in a stripe shape was arranged above the substrate to selectively expose with ultraviolet ray the liquid crystalline monomer mixture containing the dichromatic pigment transmitting green light (G) using the patterned mask. Then, the used patterned mask was removed, and portions which have not been exposed in the liquid crystalline monomer 22b were further removed through the development to form a patterned green (G) color polarizing layer 22b, where the patterned green (G) color polarizing layer 22b is spatially separated from the patterned red (R) color polarizing layer 22a.

Then, after applying a liquid crystalline monomer mixture 22c containing a dichromatic pigment transmitting blue light (B) on the blue (B) color polarizing layer 22d, a patterned mask (not shown) in a stripe shape was arranged above the substrate to selectively expose with ultraviolet ray the liquid crystalline monomer mixture containing the dichromatic pigment transmitting blue light (B) using the patterned mask. Then, the used patterned mask was removed, and portions which have not been exposed in the liquid crystalline monomer 22c were further removed through the development to form a patterned blue (B) color polarizing layer 22c, where the patterned blue (B) color polarizing layer 22c is spatially separated from the patterned green (G) color polarizing layer 22b.

Through the above processes, a color polarizing layer 22 comprising the red (R) color polarizing layer 22a, the green (G) color polarizing layer 22b, and the blue (B) color polarizing layer 22c which are spatially separated was formed.

Then, by going through the same processes as the second embodiment, the structure of the liquid crystal displaying device according to the present embodiment is completed.

As described above, according to the present embodiment same as the above embodiment, in the optical modulating display device, specifically the liquid crystal displaying device, the low refraction layer being in contact with the inner surface of the substrate inside which illuminating light passes on and being lower in refractive index than the substrate is provided, thereby ensuring a sufficient amount of guide light propagating inside the substrate and reducing non-uniformity in display illumination, and further reducing in thickness and weight of a display apparatus mounting these thereon to enable a high quality display.

### Fifth Embodiment

The present invention may adopt a constitution in which a displaying device is illuminated from a second substrate side opposite to a first substrate of an observer's side, namely a back light type constitution, as a substitute for a constitution that the displaying device is illuminated from the first substrate of the observer's side.

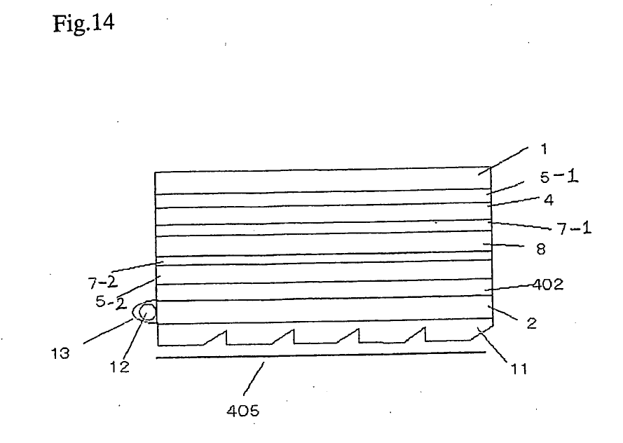

FIG. 14 is a cross-sectional view of an optical modulating display device according to fifth embodiment of the present invention. The optical modulating display device in the present embodiment will be described using a liquid crystal displaying device as an example. A liquid crystal displaying device comprises a multilayer structure containing a liquid crystal layer 8 and a pair of first transparent substrate 2 and second transparent substrate 1 sandwiching the multilayer structure. The multilayer structure is constituted of a laminated body comprising a first polarizing layer 5-1, a color filter layer 4, a first transparent electrode layer 7-1, a liquid crystal layer 8, a second transparent electrode layer 7-2, and a second polarizing layer 5-2 as well as a low refraction layer 402 comprising a transparent material layer being lower in refractive index than the first transparent substrate 2, in this order viewed from the observer's side.

Also, at least a light source 12 and a reflector 13 for collecting source light from the light source 12 on a first side of the first transparent substrate 2 are arranged on the first side of the first transparent substrate 2. Mirror finish is also applied on at least the first side of the first transparent substrate 2 so as to remove flaw scattering the light.

A protruded portion 11 for reflecting the light incoming from the first side of the first transparent substrate 2 in a direction of the liquid crystal layer 8 is further provided on a surface of the first transparent substrate 2.

A reflector 405 is further provided outside the first transparent substrate 2 and thereby reflecting the light leaked from a protruded portion 11 in a direction of the liquid crystal layer 8.

The structure of the liquid crystal displaying device according to the present embodiment was prepared by forming each layer in the same manner as a forming process described in the third embodiment and assembling them in a same manner. However, each absorption axis of the first and second polarizing layers 5-1 and 5-2 is at right angles to each other and a orientating direction of the liquid crystal layer 8 is further consistent with either of absorption axis of the polarizing layer. When assembling the liquid crystal displaying portion, a liquid crystal inlet is also provided at a side of an opposite direction to a light source contacting surface, thereby facilitating connection of the light source 12 and the first transparent substrate 2.

As described above, according to the same embodiment as the above embodiment, in the optical modulating display device, specifically the liquid crystal displaying device, the low refraction layer being in contact with the inner surface of the substrate inside which illuminating light propagates and being lower in refractive index than the substrate is provided, thereby ensuring a sufficient amount of guide light propagating inside the substrate, reducing non-uniformity in display illumination, further reducing in thickness and weight of a display apparatus mounting these thereon to enable a high quality display.

### Sixth Embodiment

The present embodiment is the same constitution as the above embodiment, however as shown in FIG. 4, a protruded portion 11 is formed in a displaying region 500, namely in an almost same region 501 as the region used for display.

Thus, meaningless light emerged into an optical modulating layer is reduced, thereby to enable optical usability to be improved. Scattered light resulting from the meaningless emerged light is further restrained, whereby visual quality may be improved. A displaying device in the present embodiment may be prepared in the same manner as the above third embodiment. However, a region where protrusions exist of which the cross-sectional shape formed on a metal mold 15 is almost saw-tooth appearance is nearly same as the displaying region, and a region where the protrusions exist when pressing the metal mold 15 on a displaying portion 14 is consistent with the displaying region, namely is performed an overlay alignment therewith, thereby to prepare the displaying device.

As described above, according to the same embodiment as the above embodiment, in the optical modulating display device, specifically the liquid crystal displaying device, the low refraction layer being in contact with the inner surface of the substrate inside which illuminating light propagates and being lower in refractive index than the substrate is provided, thereby ensuring a sufficient amount of guide light propagating inside the substrate, reducing non-uniformity in display illumination, further reducing in thickness and weight of a display apparatus mounting these thereon to enable a high quality display.

### Seventh Embodiment

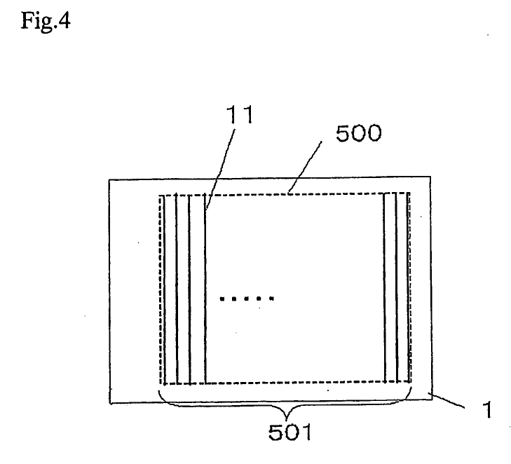

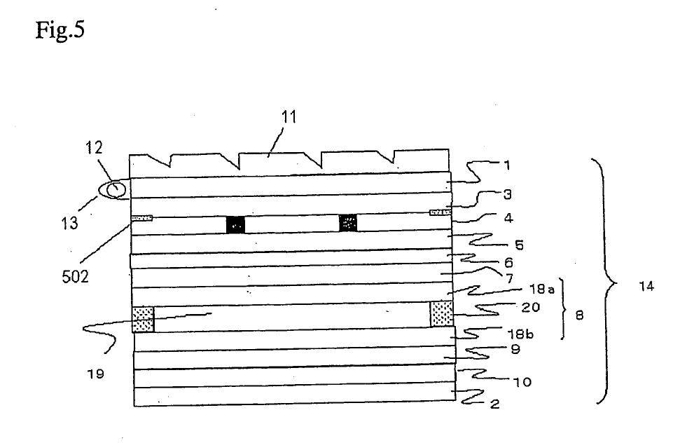

A structure of a liquid crystal displaying device according to the present embodiment is illustrated in FIG. 5. The structure of the liquid crystal displaying device shown in FIG. 5 is almost same as the structure obtained through the production method according to the third embodiment described in reference to FIG. 10A to 10F and FIG. 11A to 11D, however it is different in a point that a light blocking layer 502 for hiding a seal agent 20 is selectively formed between a low refraction layer 3 and a color filter layer 4, where the light blocking layer 502 is arranged so as to be adjusted with the seal agent 20, namely to overlap the same, viewed as a plane. Thus, by providing the light blocking layer 502, the seal agent prevents outgoing light into an optical modulating layer, namely a liquid crystal layer 8, from scattering, thereby deterioration of visual quality may be prevented. In addition, in FIG. 5, a region expressed in black in the color filter layer 4 shows that color polarizing layers of three primary colors constituting the color filter layer 4 are spatially separated from each other.

In a production method described in the above embodiment, the structure according to the present embodiment was prepared by forming a transparent material layer being lower in refractive index than a substrate thereafter applying a black resist, performing a pattern exposure, developing, and fixing to form the light blocking layer, then laminating each layer as shown in the above embodiment.

In addition, also in the case that a light absorbing agent such as black pigment is mixed to the seal agent instead of the light blocking layer 502, the same effect may be obtained as the present embodiment.

As described above, according to the present embodiment same as the above embodiment, in the optical modulating display device, specifically the liquid crystal displaying device, the low refraction layer being in contact with the inner surface of the substrate inside which illuminating light propagates and being lower in refractive index than the substrate is provided, thereby ensuring a sufficient amount of guide light propagating inside the substrate, reducing non-uniformity in display illumination, further reducing in thickness and weight of a display apparatus mounting these thereon to enable a high quality display.

### Eighth Embodiment

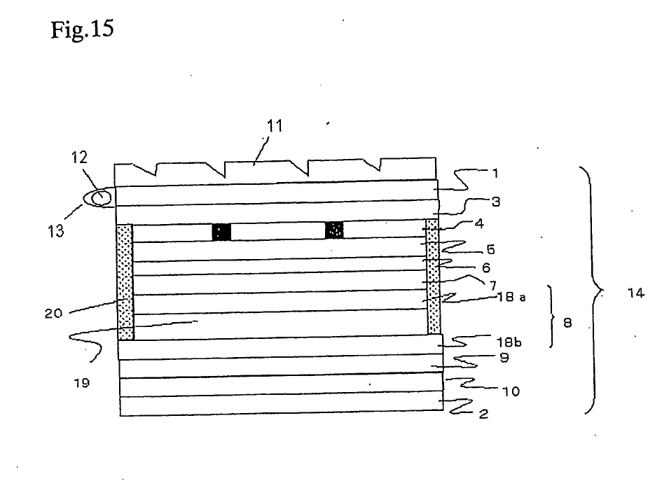

A structure of a liquid crystal displaying device according to the present embodiment is illustrated in FIG. 15. The structure of the liquid crystal displaying device shown in FIG. 15 is different from the structure described in reference to FIG. 5 in the above seventh embodiment in a point described below. According to the structure shown in FIG. 5, a seal agent 20 is positioned at an outer peripheral portion of a liquid crystal 19 in a liquid crystal layer 8 and sandwiched in adjacent spaces of a first and a second directing layers 18a and 18b of the liquid crystal layer 8. And a light blocking layer 502 is arranged so as to be adjusted with, namely overlap, the seal agent 20. Correspondingly, according to the structure shown in FIG. 15 in the present embodiment, the seal agent 20 exists not only at the outer periphery portion of the liquid crystal 19 in the liquid crystal layer 8, but also at the outer periphery portion of the first directing layer 18a, a transparent electrode layer 7, a phase difference layer 6, a polarizing layer 5, and a color filter layer 4, instead of not providing with the light blocking layer 502. In other words, the first directing layer 18a, a transparent electrode layer 7, a phase difference layer 6, a polarizing layer 5, and a color filter layer 4 do not exist on the seal agent 20. Thus, striping off in each layer forming a multilayer structure is restrained and reliability may be improved.

The above structure according to the present embodiment was prepared by applying selectively material of each layer through a printing method while avoiding a region applied with the seal agent 20 when forming the first directing layer 18a, a transparent electrode layer 7, a phase difference layer 6, a polarizing layer 5, and a color filter layer 4.

As described above, according to the present embodiment same as the above embodiment, in the optical modulating display device, specifically the liquid crystal displaying device, the low refraction layer being in contact with the inner surface of the substrate inside which illuminating light propagates and being lower in refractive index than the substrate is provided, thereby ensuring a sufficient amount of guide light propagating inside the substrate, reducing non-uniformity in display illumination, further reducing in thickness and weight of a display apparatus mounting these thereon to enable a high quality display.

### Ninth Embodiment

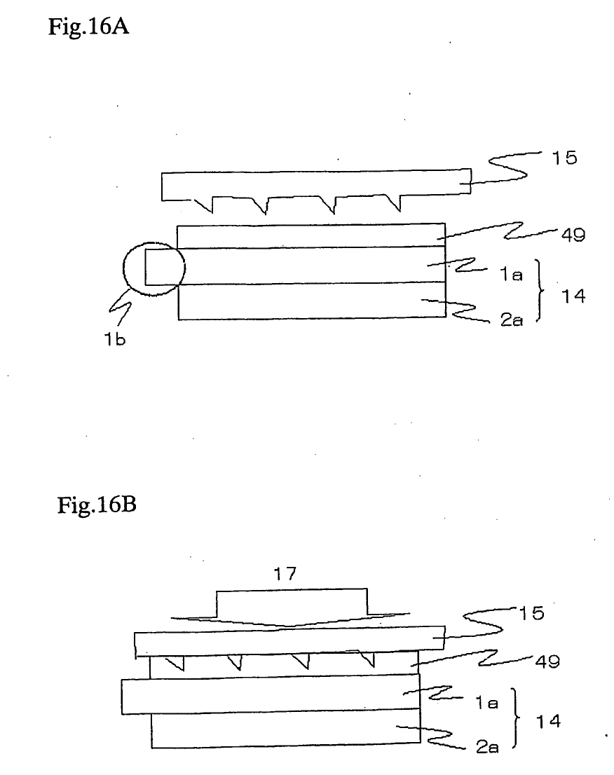

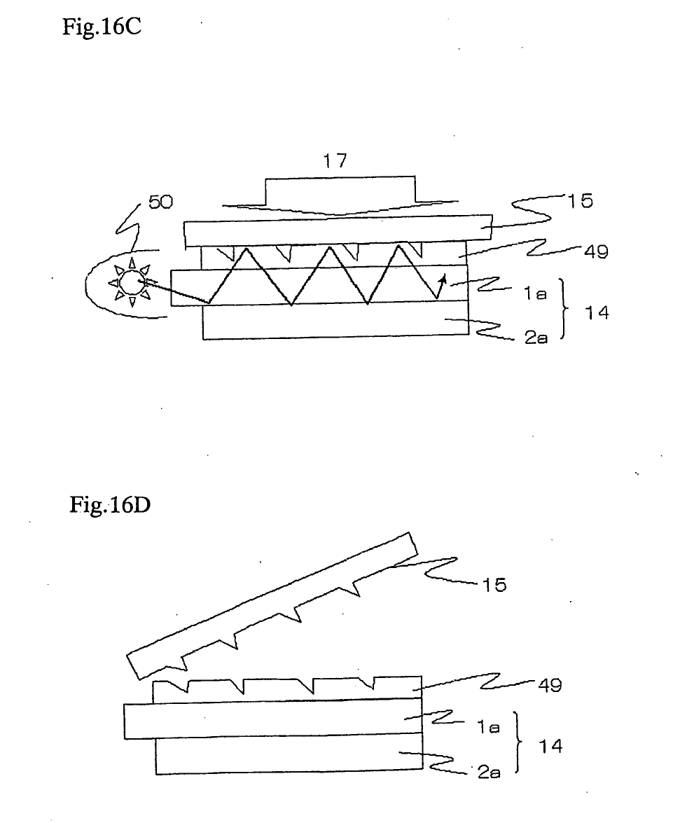

FIG. 16A to 16D are views showing production processes of a liquid crystal displaying device according to ninth embodiment of the present invention. Constituents same as the third embodiment are shown in the same symbols. Difference between the third embodiment and the present ninth embodiment is in a point that both are different in a production method for protruded portion 11.

As shown in FIG. 16A, a liquid crystal displaying portion 14 prepared in the third embodiment was arranged so that a first glass substrate 1a is positioned in a upper position in the figure. UV curing transparent resin is applied on the liquid crystal displaying portion 14 to form a transparent resin layer 49.

As shown in FIG. 16B, a protruded shape of which a cross-sectional shape was almost V-shape was scattered in dotted form within a displaying surface, or a metal mold 15 formed in a linear form was arranged in an upper position of the transparent resin layer 49, and pressure 17 was applied from above to print the protruded shape of the metal mold 15 on the transparent resin layer 49.

As shown in FIG. 16C, while applying pressure from above, ultraviolet light 50 is introduced from first side end of a first substrate 1a of the liquid crystal displaying portion 14 into the first substrate 1a to polymerize and harden up the UV curing resin.

As shown in FIG. 16D, the metal mold 15 was striped off from the transparent resin layer 49 formed on the liquid crystal displaying portion 14. Thereby, the protruded shape of the metal mold 15 was printed on the transparent resin layer 49 and the first glass substrate 1a and the transparent resin layer 49 was in optically close contact with each other. Thereby, the protruded portion 11 is formed on the first glass substrate 1a and then the displaying device in the present embodiment is completed.

As described above, according to the present embodiment same as the above embodiment, in the optical modulating display device, specifically the liquid crystal displaying device, the low refraction layer being in contact with the inner surface of the substrate inside which illuminating light propagates and being lower in refractive index than the substrate is provided, thereby ensuring a sufficient amount of guide light propagating inside the substrate, reducing non-uniformity in display illumination, further reducing in thickness and weight of a display apparatus mounting these thereon to enable a high quality display.

### Tenth Embodiment

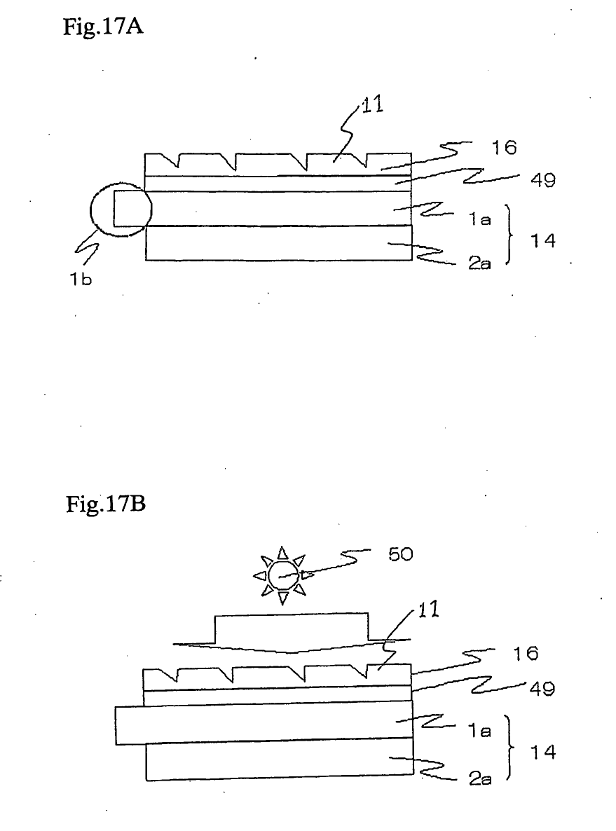

FIGS. 17A and 17B are views illustrating a production process for a liquid crystal displaying device according to tenth embodiment of the present invention. Constituents same as the third embodiment are shown in the same symbols. Difference between the third embodiment and the present tenth embodiment is in a point of a production method for a protruded portion 11.

As shown in FIG. 17A, a liquid crystal displaying portion 14 prepared in the third embodiment was arranged so that a first glass substrate 1a is in an upper position in the figure. UV curing resin being almost the same in refractive index as the first transparent substrate, or UV curing transparent resin being almost the same in refractive index as a transparent resin sheet, is applied on the first transparent substrate to form a transparent resin layer 49.

A protruded shape of which a cross-sectional shape was almost V-shape was scattered in dotted form within a displaying surface on the transparent resin layer 49 or the transparent resin sheet 16 formed in a linear form was attached thereon.

As shown in FIG. 17B, ultraviolet ray 50 is illuminated from above the liquid crystal displaying portion 14, and a UV curing resin forming the transparent resin layer 49 is polymerized and hardened, thereby the first transparent substrate 1a and the transparent resin sheet 16 are brought into optically close contact with each other. Thus, the protruded portion 11 is formed on the first glass substrate 1a to complete the liquid crystal displaying device in the present embodiment.

As described above, according to the present embodiment same as the above embodiment, in the optical modulating display device, specifically the liquid crystal displaying device, the low refraction layer being in contact with the inner surface of the substrate inside which illuminating light propagates and being lower in refractive index than the substrate is provided, thereby ensuring a sufficient amount of guide light propagating inside the substrate, reducing non-uniformity in display illumination, further reducing in thickness and weight of a display apparatus mounting these thereon to enable a high quality display.

### Eleventh Embodiment

In eleventh embodiment of the present invention, a liquid crystal displaying device prepared in the above embodiment is divided into two or more displaying devices to simultaneously prepare at least two or more liquid crystal displaying devices. Namely, after assembling a displaying portion 14, a protruded portion 11 is formed, thereafter the liquid crystal displaying device is divided into a plurality of individual displaying devices to simultaneously prepare at least two or more liquid crystal displaying devices. Thereby, reliability of process is improved and yield ratio is enhanced. Moreover, two or more liquid crystal displaying devices are simultaneously formed to enable production cost to be reduced.

As described above, according to the present embodiment same as the above embodiment, in the optical modulating display device, specifically the liquid crystal displaying device, the low refraction layer being in contact with the inner surface of the substrate inside which illuminating light propagates and being lower in refractive index than the substrate is provided, thereby ensuring a sufficient amount of guide light propagating inside the substrate, reducing non-uniformity in display illumination, further reducing in thickness and weight of a display apparatus mounting these thereon to enable a high quality display.

### Twelfth Embodiment

According to twelfth embodiment in the present invention, before assembling a pair of first and second substrates, a score is previously provided on one or both inner surfaces of the first and second substrates or a surface facing in a direction in which an optical modulating layer or liquid crystal layer exist when assembling the first and second substrates. After forming protrusions and grooves on the surface of an observer's side of a protruded portion 11, a displaying device is divided into a plurality of individual displaying devices. Specifically, after forming a multilayer structure on each substrate through a method described in the above embodiment, a score is previously provided to fit a cutting section which finally dividing the displaying device into a plurality of individual displaying devices. Thereafter, assembly of the displaying portion is performed and further the protruded portion 11 is formed to simultaneously prepare at least two or more displaying devices by cutting the displaying device along the score. Thereby, yield ratio in process of division may be improved.

As described above, according to the present embodiment same as the above embodiment, in the optical modulating display device, specifically the liquid crystal displaying device, the low refraction layer being in contact with the inner surface of the substrate inside which illuminating light propagates and being lower in refractive index than the substrate is provided, thereby ensuring a sufficient amount of guide light propagating inside the substrate, reducing non-uniformity in display illumination, further reducing in thickness and weight of a display apparatus mounting these thereon to enable a high quality display.

### Thirteenth Embodiment

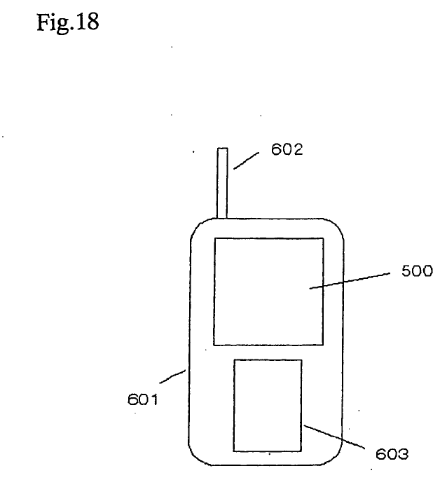

FIG. 18 is a front view showing a cellular phone as a display apparatus according to thirteenth embodiment in the present invention. In the present embodiment, the cellular phone is provided with it in a condition in which the displaying region of an optical modulating display device according to the above embodiment is observable. For instance, as shown in FIG. 18, the cellular phone includes a main body 601, an antenna 602, an operational region 603, and a displaying portion 500. According to the present invention, a displaying device can be reduced in thickness and weight and a high quality display is enabled.

In the present embodiment, the cellular phone is shown as the display apparatus, however the display apparatus is not limited to the cellular phone.

In addition, the present invention is not limited to the each embodiment, and it is obvious that each embodiment may be suitably modified within a scope of technical thought of the present invention.

### INDUSTRIAL APPLICABILITY

As described above, a low refraction layer being in contact with an inner surface of a substrate inside which illuminating light propagates and being lower in refractive index than the substrate is provided in an optical modulating display device, specifically a liquid crystal displaying device, thereby achieving the optical modulating display device provided with an improved flat type illuminating device. This enables a sufficient amount of guide light propagating inside the substrate to be ensured and non-uniformity in display illumination to be reduced, further enables a display apparatus mounting these thereon to be reduced in thickness and weight and a high quality display to be achieved.

What is claimed is:

1. An optical modulating/displaying device including at least:
a first and second substrates forming a pair, wherein at least the first substrate is constituted so that light propagates therein;
a light source provided in the vicinity of first side end of the first substrate;
a multilayer structure sandwiched between the first and second substrates, which includes a low refraction layer being lower in refractive index than the first substrate and further being in direct contact with the first substrate, a first transparent electrode layer, a first insulating layer, a charged fine particle filled layer, a second insulating layer, and a second transparent electrode layer; and
a reflection structure for reflecting at a right angle, or nearly right angle, to the boundary surface at least a part of light entering in an oblique direction from the first substrate at an opposite side to the low refraction layer with reference to the first substrate:
wherein a boundary surface between the first substrate and the low refraction layer causes total reflection of light entering into the boundary surface in an oblique direction.

2. An optical modulating/displaying device as claimed in claim 1, wherein a refractive index (nL) of the low refraction layer and a refractive index (nl) of the first substrate meet a condition given by nL−nl<−0.01.

3. An optical modulating/displaying device as claimed in claim 1, wherein the reflection structure comprises a layered structure having at least either of a plurality of protrusions and a plurality of grooves at an opposite side to the first substrate.

4. An optical modulating/displaying device as claimed in claim 3, wherein at least either of the plurality of protrusions and the plurality of grooves exist in almost the same region as a displaying region of the optical modulating/displaying device.

5. An optical modulating/displaying device as claimed in claim 1, wherein the low refraction layer comprises a transparent material.

6. An optical modulating/displaying device as claimed in claim 1, wherein the low refraction layer comprises SiO₂.

7. An optical modulating/displaying device as claimed in claim 1, wherein the low refraction layer comprises MgF.

8. A production method for an optical modulating/displaying device, comprising the steps of:
manufacturing an optical modulating device including a first substrate constituted so that light propagates therein, a second substrate forming a counterpart to the first substrate, a multilayer structure sandwiched between the first and the second substrates, which includes an optical modulating layer and a low refraction layer being in contact with the first substrate and comprising a material being lower in refractive index than the first substrate; and
then, forming a reflection structure for reflecting at a right angle, or nearly right angle, to the boundary surface at least a part of light entering in an oblique direction from the first substrate at an opposite side to the low refraction layer with reference to the first substrate in the optical modulating device.

9. A production method for an optical modulating/displaying device as claimed in claim 8, wherein the step of forming the reflection structure comprises the steps of:
applying a UV curing transparent resin on an opposite side of the first substrate;
pressing a metal mold having at least either of a plurality of protrusions and a plurality of grooves on the UV curing transparent resin, while pressing, introducing ultraviolet ray into the first substrate from first side end of the first substrate, and hardening the UV curing transparent resin, thereby printing the shape of the metal mold on the UV curing transparent resin.

10. A production method of an optical modulating/displaying device as claimed in claim 8, wherein the step of forming the reflection structure further comprises the steps of:
forming a transparent resin sheet at an opposite side of a first substrate;
pressing a metal mold having at least either of a plurality of protrusions or a plurality of grooves on the transparent resin and applying pressure thereon, and while applying the pressure thereon, heating the transparent resin sheet up to a temperature of a glass transition point or higher of the transparent resin sheet, followed by printing the shape of the metal mold on the transparent resin sheet;
while continuing to apply the pressure thereon, cooling down the transparent resin sheet up to room temperature; and
striping off the metal mold from the transparent resin sheet.

11. A production method of an optical modulating/displaying device as claimed in claim 8, further comprising the steps of:
forming the reflection structure; and
thereafter, further dividing the optical modulating/displaying device into a plurality of individual optical modulating/displaying devices.

12. A production method of an optical modulating/displaying device as claimed in claim 11, wherein the step of manufacturing the optical modulating device further comprises the steps of assembling the pair of first and second substrates and providing previously a score at a side where the optical modulating layer in at least one of the first and second substrates further exist before the step of assembling.
